(19) United States
(12) Patent Application Publication
(10) Pub. No.: US 2025/0365666 A1
(43) Pub. Date: Nov. 27, 2025

(54) ASYNCHRONOUS UPLINK TRIGGER DESIGN

(71) Applicant: QUALCOMM Incorporated, San Diego, CA (US)

(72) Inventors: Xiaojie WANG, Hillsborough, NJ (US); Piyush GUPTA, Bridgewater, NJ (US); Luanxia YANG, Beijing (CN); Junyi LI, Greentown, PA (US)

(21) Appl. No.: 18/874,229

(22) PCT Filed: Aug. 30, 2022
(86) PCT No.: PCT/CN2022/115713

§ 371 Date: Dec. 12, 2024

(51) Int. Cl. H04W 52/02; H04W 24/08

(52) U.S. Cl. CPC H04W 52/0235; H04W 24/08

(57) ABSTRACT

Methods, systems, and devices for wireless communications are described. Some wireless communications systems may support asynchronous uplink triggers. For example, a user equipment (UE) may receive, from a network entity, an indication of parameters associated with an uplink trigger configuration, where the parameters are associated with energy scheduling request, communication scheduling requests, or both. Additionally, the UE may transmit, via an active radio (AR), an uplink trigger based on the uplink trigger configuration, where the uplink trigger includes the energy scheduling requests, the communication scheduling requests, or both. Further, the UE may monitor, via a backscatter radio (BR), for energy grants, communication grants, or both, based on the uplink trigger, where the monitoring is based on the uplink trigger configuration. In some cases, the UE may receive, via the BR, the energy grants, the communication grants, or both, based on the monitoring.

### CROSS REFERENCE

The present application is a 371 national phase filing of International PCT Application No. PCT/CN2022/115713 by WANG et al., entitled “ASYNCHRONOUS UPLINK TRIGGER DESIGN,” filed Aug. 30, 2022, which is assigned to the assignee hereof, and which is expressly incorporated by reference in its entirety herein.

### FIELD OF TECHNOLOGY

The following relates to wireless communications, including asynchronous uplink trigger design.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The described techniques relate to improved methods, systems, devices, and apparatuses that support asynchronous uplink trigger design. Generally, the techniques described herein may enable a user equipment (UE), including an active radio (AR) component and a backscatter radio (BR) component, to transmit an uplink trigger, including an energy scheduling request (ESR), a communication scheduling request (CSR), or both, according to an uplink trigger configuration. For example, the UE may receive, from a network entity, an indication of parameters associated with the uplink trigger configuration, where the parameters are associated with ESRs, CSRs, or both. Additionally, the UE may transmit, via an AR (e.g., using the AR component), an uplink trigger based on the uplink trigger configuration, where the uplink trigger includes the ESRs, the CSRs, or both. In some cases, the uplink trigger may include an indication of a UE group associated with the UE, a UE identifier associated with the UE, a cell group associated with the UE, a cell identifier of the cell group associated with the UE, or any combination thereof. The UE may transmit, via a BR (e.g., using the BR component) an acknowledgment message indicating reception of the parameters associated with the uplink trigger configuration and may monitor, via the BR, for energy grants, communications grants, or both, based on the uplink trigger.

The UE may monitor for the energy grants, the communications grants, or both, for a duration indicated in the uplink trigger configuration. In some cases, the UE may receive, via the BR, the energy grants, the communication grants, or both, based on the monitoring. Alternatively, the UE may fail to receive, via the BR, the energy grants, the communication grants, or both, and may transmit a retransmission of the uplink trigger.

A method for wireless communications at a UE is described. The method may include receiving, from a network entity, an indication of parameters associated with an uplink trigger configuration, where the parameters are associated with ESRs, CSRs, or both, transmitting, via an AR, an uplink trigger based on the uplink trigger configuration, where the uplink trigger includes the ESRs, the CSRs, or both, and monitoring, via a BR, for energy grants, communication grants, or both, based on the uplink trigger, where the monitoring is based on the uplink trigger configuration.

An apparatus for wireless communications at a UE is described. The apparatus may include a processor, memory coupled with the processor, and instructions stored in the memory. The instructions may be executable by the processor to cause the apparatus to receive, from a network entity, an indication of parameters associated with an uplink trigger configuration, where the parameters are associated with ESRs, CSRs, or both, transmit, via an AR, an uplink trigger based on the uplink trigger configuration, where the uplink trigger includes the ESRs, the CSRs, or both, and monitor, via a BR, for energy grants, communication grants, or both, based on the uplink trigger, where the monitoring is based on the uplink trigger configuration.

Another apparatus for wireless communications at a UE is described. The apparatus may include means for receiving, from a network entity, an indication of parameters associated with an uplink trigger configuration, where the parameters are associated with ESRs, CSRs, or both, means for transmitting, via an AR, an uplink trigger based on the uplink trigger configuration, where the uplink trigger includes the ESRs, the CSRs, or both, and means for monitoring, via a BR, for energy grants, communication grants, or both, based on the uplink trigger, where the monitoring is based on the uplink trigger configuration.

A non-transitory computer-readable medium storing code for wireless communications at a UE is described. The code may include instructions executable by a processor to receive, from a network entity, an indication of parameters associated with an uplink trigger configuration, where the parameters are associated with ESRs, CSRs, or both, transmit, via an AR, an uplink trigger based on the uplink trigger configuration, where the uplink trigger includes the ESRs, the CSRs, or both, and monitor, via a BR, for energy grants, communication grants, or both, based on the uplink trigger, where the monitoring is based on the uplink trigger configuration.

Some examples of the method, apparatuses, and non-transitory computer-readable medium described herein may further include operations, features, means, or instructions for receiving, via the BR, the energy grants, the communication grants, or both, based on the monitoring.

Some examples of the method, apparatuses, and non-transitory computer-readable medium described herein may further include operations, features, means, or instructions for transmitting, via the AR, a retransmission of the uplink trigger, based on failing to receive, via the BR, the energy grants, the communication grants, or both.

Some examples of the method, apparatuses, and non-transitory computer-readable medium described herein may further include operations, features, means, or instructions for transmitting, via the BR, an acknowledgment message indicating reception of the parameters associated with the uplink trigger configuration.

Some examples of the method, apparatuses, and non-transitory computer-readable medium described herein may further include operations, features, means, or instructions for transmitting a quantity of repetitions of the uplink trigger, where the quantity of repetitions may be based on a coverage level of the UE, one or more signal measurements, a priority associated with the uplink trigger, the monitoring, or any combination thereof.

In some examples of the method, apparatuses, and non-transitory computer-readable medium described herein, transmitting a quantity of repetitions of the uplink trigger may include operations, features, means, or instructions for transmitting the first quantity of repetitions, the second quantity of repetitions, or the third quantity of repetitions based on a set of thresholds associated with the first coverage level, the second coverage level, the third coverage level, or any combination thereof.

Some examples of the method, apparatuses, and non-transitory computer-readable medium described herein may further include operations, features, means, or instructions for receiving, from the network entity, an indication of the first quantity of repetitions, the second quantity of repetitions, the third quantity of repetitions, the set of thresholds, or any combination thereof.

Some examples of the method, apparatuses, and non-transitory computer-readable medium described herein may further include operations, features, means, or instructions for measuring a reference signal receive power of one or more reference signal transmissions received via the BR and determining the coverage level of the UE based on the reference signal receive power of the one or more reference signal transmissions.

In some examples of the method, apparatuses, and non-transitory computer-readable medium described herein, transmitting the uplink trigger may include operations, features, means, or instructions for transmitting, via the AR, an indication of a UE group associated with the UE, a UE identifier associated with the UE, a cell group associated with the UE, a cell identifier of the cell group associated with the UE, or any combination thereof, where the uplink trigger includes the indication.

In some examples of the method, apparatuses, and non-transitory computer-readable medium described herein, the parameters associated with the ESRs, the CSRs, or both, include a first parameter associated with a duration of a monitoring window and monitoring for the energy grants, the communication grants, or both, may be based on the monitoring window.

In some examples of the method, apparatuses, and non-transitory computer-readable medium described herein, receiving the indication of the parameters associated with the uplink trigger configuration may include operations, features, means, or instructions for receiving an indication of one or more waveforms associated with transmission of the uplink trigger, where the parameters include the indication of the one or more waveforms, and where transmitting the uplink trigger may be based on the one or more waveforms.

In some examples of the method, apparatuses, and non-transitory computer-readable medium described herein, the one or more waveforms may be associated with one or more uplink trigger sequences.

In some examples of the method, apparatuses, and non-transitory computer-readable medium described herein, a first set of uplink trigger sequences from the one or more uplink trigger sequences may be associated with the ESRs and a second set of uplink trigger sequences from the one or more uplink trigger sequences may be associated with the CSRs and the method, apparatuses, and non-transitory computer-readable medium may include further operations, features, means, or instructions for generating the first set of uplink trigger sequences and the second set of uplink trigger sequences based on a UE identifier, a cell identifier associated with the UE, or both.

In some examples of the method, apparatuses, and non-transitory computer-readable medium described herein, receiving the indication of the parameters associated with the uplink trigger configuration may include operations, features, means, or instructions for receiving an indication of a scrambling sequence, where the scrambling sequence may be based on an identifier associated with the network entity and generating the one or more uplink trigger sequences based on the scrambling sequence.

In some examples of the method, apparatuses, and non-transitory computer-readable medium described herein, the scrambling sequence may be based on a system frame number (SFN), a slot index, a counter, or any combination thereof.

In some examples of the method, apparatuses, and non-transitory computer-readable medium described herein, each of the one or more uplink trigger sequences may be preceded by a training sequence, followed by a training sequence, or both.

In some examples of the method, apparatuses, and non-transitory computer-readable medium described herein, each of the one or more uplink trigger sequences may be associated with a preamble.

In some examples of the method, apparatuses, and non-transitory computer-readable medium described herein, the one or more waveforms may be associated with one or more chirps and a first set of chirps from the one or more chirps may be associated with the ESRs and a second set of chirps from the one or more chirps may be associated with the CSRs.

In some examples of the method, apparatuses, and non-transitory computer-readable medium described herein, receiving the indication of the parameters associated with the uplink trigger configuration may include operations, features, means, or instructions for receiving an indication of a format associated with the uplink trigger, where the format includes a header, an address, an indication of the ESRs, the CSRs, or both, a cyclic redundancy check (CRC), a training sequence, or any combination thereof and transmitting, via the AR, the uplink trigger in accordance with the indicated format.

Some examples of the method, apparatuses, and non-transitory computer-readable medium described herein may further include operations, features, means, or instructions for receiving, from the network entity, control signaling indicating a duty cycle configuration associated with transmission of the uplink trigger, where transmitting the uplink trigger may be based on the duty cycle configuration.

In some examples of the method, apparatuses, and non-transitory computer-readable medium described herein, the duty cycle configuration may be based on a congestion level, a priority associated with the ESRs, a priority associated with the CSRs, an energy state of the UE, a power consumption associated with the transmission of the uplink trigger.

Some examples of the method, apparatuses, and non-transitory computer-readable medium described herein may further include operations, features, means, or instructions for transmitting, to the network entity, a report including an indication of one or more energy consumptions associated with the transmission of the uplink trigger at different transmit power levels, a recommended duty cycle configuration, or both, where the indicated duty cycle configuration may be based on the report.

A method for wireless communications at a network entity is described. The method may include outputting an indication of parameters associated with an uplink trigger configuration, where the parameters are associated with ESRs, CSRs, or both, obtaining an uplink trigger based on the uplink trigger configuration, where the uplink trigger includes the ESRs, the CSRs, or both, and outputting energy grants, communication grants, or both, based on the uplink trigger, where the outputting is based on the uplink trigger configuration.

An apparatus for wireless communications at a network entity is described. The apparatus may include a processor, memory coupled with the processor, and instructions stored in the memory. The instructions may be executable by the processor to cause the apparatus to output an indication of parameters associated with an uplink trigger configuration, where the parameters are associated with ESRs, CSRs, or both, obtain an uplink trigger based on the uplink trigger configuration, where the uplink trigger includes the ESRs, the CSRs, or both, and output energy grants, communication grants, or both, based on the uplink trigger, where the outputting is based on the uplink trigger configuration.

Another apparatus for wireless communications at a network entity is described. The apparatus may include means for outputting an indication of parameters associated with an uplink trigger configuration, where the parameters are associated with ESRs, CSRs, or both, means for obtaining an uplink trigger based on the uplink trigger configuration, where the uplink trigger includes the ESRs, the CSRs, or both, and means for outputting energy grants, communication grants, or both, based on the uplink trigger, where the outputting is based on the uplink trigger configuration.

A non-transitory computer-readable medium storing code for wireless communications at a network entity is described. The code may include instructions executable by a processor to output an indication of parameters associated with an uplink trigger configuration, where the parameters are associated with ESRs, CSRs, or both, obtain an uplink trigger based on the uplink trigger configuration, where the uplink trigger includes the ESRs, the CSRs, or both, and output energy grants, communication grants, or both, based on the uplink trigger, where the outputting is based on the uplink trigger configuration.

Some examples of the method, apparatuses, and non-transitory computer-readable medium described herein may further include operations, features, means, or instructions for detecting one or more uplink trigger sequences associated with the uplink trigger from a set of uplink trigger sequences based on an identifier associated with a UE, where outputting the energy grants, the communication grants, or both, may be based on detecting the one or more uplink trigger sequences.

In some examples of the method, apparatuses, and non-transitory computer-readable medium described herein, detecting the one or more uplink trigger sequence may include operations, features, means, or instructions for detecting a preamble associated with the uplink trigger and searching the set of uplink trigger sequences based on detecting the preamble, where detecting the one or more uplink trigger sequences from the set of uplink trigger sequences may be based on the searching.

Some examples of the method, apparatuses, and non-transitory computer-readable medium described herein may further include operations, features, means, or instructions for estimating a frequency offset associated with the uplink trigger and a channel associated with the uplink trigger, where detecting the one or more uplink trigger sequences may be based on the frequency offset and channel.

Some examples of the method, apparatuses, and non-transitory computer-readable medium described herein may further include operations, features, means, or instructions for obtaining an acknowledgment message indicating reception of the parameters associated with the uplink trigger configuration by a UE.

Some examples of the method, apparatuses, and non-transitory computer-readable medium described herein may further include operations, features, means, or instructions for outputting an indication of a first quantity of repetitions of the uplink trigger, a second quantity of repetitions of the uplink trigger, a third quantity of repetitions of the uplink trigger, a set of thresholds, or any combination thereof, where a first coverage level of a UE may be associated with the first quantity of repetitions, a second coverage level of the UE may be associated with the second quantity of repetitions, and a third coverage level of the UE may be associated with the third quantity of repetitions, and where the set of thresholds may be associated with the first coverage level, the second coverage level, the third coverage level, or any combination thereof.

In some examples of the method, apparatuses, and non-transitory computer-readable medium described herein, obtaining the uplink trigger may include operations, features, means, or instructions for obtaining an indication of a UE group associated with a UE, a UE identifier associated with the UE, a cell group associated with the UE, a cell identifier of the cell group associated with the UE, or any combination thereof, where the uplink trigger includes the indication.

In some examples of the method, apparatuses, and non-transitory computer-readable medium described herein, the parameters associated with the ESRs, the CSRs, or both, include a first parameter associated with a duration of a monitoring window.

In some examples of the method, apparatuses, and non-transitory computer-readable medium described herein, outputting the indication of the parameters associated with the uplink trigger configuration may include operations, features, means, or instructions for outputting an indication of one or more waveforms associated with transmission of the uplink trigger by a UE, where the parameters include the indication of the one or more waveforms, and where obtaining the uplink trigger may be based on the one or more waveforms.

In some examples of the method, apparatuses, and non-transitory computer-readable medium described herein, the one or more waveforms may be associated with one or more uplink trigger sequences.

In some examples of the method, apparatuses, and non-transitory computer-readable medium described herein, a first set of uplink trigger sequences from the one or more uplink trigger sequences may be associated with the ESRs and a second set of uplink trigger sequences from the one or more uplink trigger sequences may be associated with the CSRs.

In some examples of the method, apparatuses, and non-transitory computer-readable medium described herein, outputting the indication of the parameters associated with the uplink trigger configuration may include operations, features, means, or instructions for outputting an indication of a scrambling sequence, where the scrambling sequence may be based on an identifier associated with the network entity.

In some examples of the method, apparatuses, and non-transitory computer-readable medium described herein, the scrambling sequence may be based on an SFN, a slot index, a counter, or any combination thereof.

In some examples of the method, apparatuses, and non-transitory computer-readable medium described herein, each of the one or more uplink trigger sequences may be preceded by a training sequence, followed by a training sequence, or both.

In some examples of the method, apparatuses, and non-transitory computer-readable medium described herein, each of the one or more uplink trigger sequences may be associated with a preamble.

In some examples of the method, apparatuses, and non-transitory computer-readable medium described herein, the one or more waveforms may be associated with one or more chirps and a first set of chirps from the one or more chirps may be associated with the ESRs and a second set of chirps from the one or more chirps may be associated with the CSRs.

In some examples of the method, apparatuses, and non-transitory computer-readable medium described herein, outputting the indication of the parameters associated with the uplink trigger configuration may include operations, features, means, or instructions for outputting an indication of a format associated the uplink trigger, where the format includes a header, an address, an indication of the ESRs, the CSRs, or both, a CRC, a training sequence, or any combination thereof and obtaining the uplink trigger in accordance with the indicated format.

Some examples of the method, apparatuses, and non-transitory computer-readable medium described herein may further include operations, features, means, or instructions for outputting control signaling indicating a duty cycle configuration associated with transmission of the uplink trigger, where obtaining the uplink trigger may be based on the duty cycle configuration.

In some examples of the method, apparatuses, and non-transitory computer-readable medium described herein, the duty cycle configuration may be based on a congestion level, a priority associated with the ESRs, a priority associated with the CSRs, an energy state of a UE, a power consumption associated with the transmission of the uplink trigger.

Some examples of the method, apparatuses, and non-transitory computer-readable medium described herein may further include operations, features, means, or instructions for receiving a report including an indication of one or more energy consumptions associated with transmission of the uplink trigger at different transmit power levels, a recommended duty cycle configuration, or both, where the indicated duty cycle configuration may be based on the report.

### BRIEF DESCRIPTION OF THE DRAWINGS

FIG. 1 illustrates an example of a wireless communications system that supports asynchronous uplink trigger design in accordance with one or more aspects of the present disclosure.

FIG. 2 illustrates an example of a wireless communications scheme that supports asynchronous uplink trigger design in accordance with one or more aspects of the present disclosure.

FIG. 3 illustrates an example of an uplink trigger procedure that supports asynchronous uplink trigger design in accordance with one or more aspects of the present disclosure.

FIGS. 4A and 4B each illustrate an example of an uplink trigger format that supports asynchronous uplink trigger design in accordance with one or more aspects of the present disclosure.

FIG. 5 illustrates an example of a process flow that supports asynchronous uplink trigger design in accordance with one or more aspects of the present disclosure.

FIGS. 6 and 7 show block diagrams of devices that support asynchronous uplink trigger design in accordance with one or more aspects of the present disclosure.

FIG. 8 shows a block diagram of a communications manager that supports asynchronous uplink trigger design in accordance with one or more aspects of the present disclosure.

FIG. 9 shows a diagram of a system including a device that supports asynchronous uplink trigger design in accordance with one or more aspects of the present disclosure.

FIGS. 10 and 11 show block diagrams of devices that support asynchronous uplink trigger design in accordance with one or more aspects of the present disclosure.

FIG. 12 shows a block diagram of a communications manager that supports asynchronous uplink trigger design in accordance with one or more aspects of the present disclosure.

FIG. 13 shows a diagram of a system including a device that supports asynchronous uplink trigger design in accordance with one or more aspects of the present disclosure.

FIGS. 14 through 17 show flowcharts illustrating methods that support asynchronous uplink trigger design in accordance with one or more aspects of the present disclosure.

### DETAILED DESCRIPTION

Some wireless communications systems may support wireless devices with limited power capabilities (e.g., Ultra-light internet of things (IoT) devices). For example, a wireless device, such as a user equipment (UE), may be powered by small batteries or may harvest energy from the environment, such as from energy signals, solar power, or the like thereof, to support operations of the UE. Additionally, the UE may support communication via multiple radio types. For example, the UE may support communications (e.g., reader-initiated communications) via a backscatter radio (BR) and communications (e.g., tag-initiated) via an active radio (AR). In some cases, the BR, the AR, or both, may operate synchronously, such that the BR, AR, or both, may transmit communications according to timing indicated by a network entity, or may operate asynchronously, such that the BR, AR, or both, may transmit communications not according to timing indicated by the network entity. For example, AR components of the UE may transmit one or more uplink triggers, including energy scheduling requests (ESRs), communication scheduling requests (CSRs), or both, in an asynchronous manner. While operating asynchronously may support power saving (e.g., due to not having to perform synchronization procedures), frequency errors may occur during transmission of communications, such as uplink trigger transmissions. As such, enhances procedures for transmission of asynchronous uplink triggers may be desired.

Accordingly, techniques described herein may support asynchronous transmission of uplink triggers. For example, a network entity may transmit, to a UE, an indication of parameters associated with an uplink trigger configuration. The parameters may include a duration associated with a monitoring window, parameters associated with one or more uplink trigger transmissions, or any combination thereof. In some cases, the parameters associated with the one or more uplink trigger transmissions may indicate one or more waveforms associated with the one or more uplink trigger transmissions. For example, the one or more waveforms may include sequence-based waveforms, chirp spreading spectrum (CSS) based waveforms, pre-configured waveforms, or any combination thereof. Additionally, the UE may determine an uplink trigger transmission opportunity based on the uplink trigger configuration and may transmit, via the AR, an uplink trigger. In some cases, the uplink trigger may include one or more ESRs, one or more CSRs, or both. The UE may monitor the BR for one or more communication grants, one or more energy grants, or both, from the network entity during the monitoring window based on the configuration and the uplink trigger transmission. In some cases, (e.g., the UE does not receive the one or more communication grants, the one or more energy grants, or both), the UE may retransmit the uplink trigger via the AR.

Aspects of the disclosure are initially described in the context of wireless communications systems. Aspects of the disclosure are then described in the context of an uplink trigger procedure, uplink trigger formats, and a process flow. Aspects of the disclosure are further illustrated by and described with reference to apparatus diagrams, system diagrams, and flowcharts that relate to asynchronous uplink trigger design.

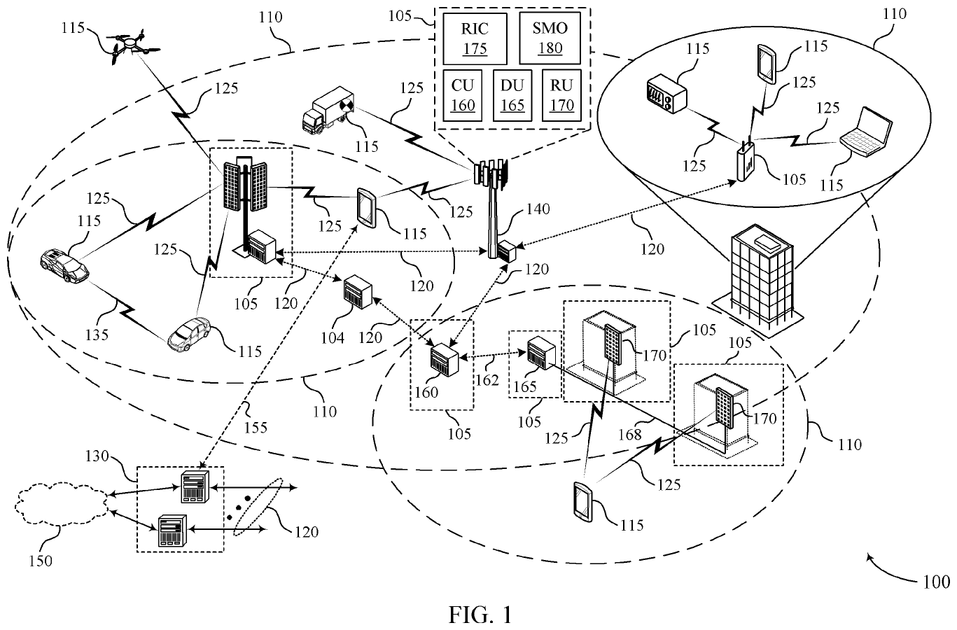

FIG. 1 illustrates an example of a wireless communications system 100 that supports asynchronous uplink trigger design in accordance with one or more aspects of the present disclosure. The wireless communications system 100 may include one or more network entities 105, one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via one or more communication links 125 (e.g., a radio frequency (RF) access link). For example, a network entity 105 may support a coverage area 110 (e.g., a geographic coverage area) over which the UEs 115 and the network entity 105 may establish one or more communication links 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices, such as other UEs 115 or network entities 105, as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with the core network 130, or with one another, or both. For example, network entities 105 may communicate with the core network 130 via one or more backhaul communication links 120 (e.g., in accordance with an S1, N2, N3, or other interface protocol). In some examples, network entities 105 may communicate with one another via a backhaul communication link 120 (e.g., in accordance with an X2, Xn, or other interface protocol) either directly (e.g., directly between network entities 105) or indirectly (e.g., via a core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication links 120, midhaul communication links 162, or fronthaul communication links 168 may be or include one or more wired links (e.g., an electrical link, an optical fiber link), one or more wireless links (e.g., a radio link, a wireless optical link), among other examples or various combinations thereof. A UE 115 may communicate with the core network 130 via a communication link 155.

One or more of the network entities 105 described herein may include or may be referred to as a base station 140 (e.g., a base transceiver station, a radio base station, an NR base station, an access point, a radio transceiver, a NodeB, an eNodeB (eNB), a next-generation NodeB or a giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within a single network entity 105 (e.g., a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among two or more network entities 105, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU) 160, a distributed unit (DU) 165, a radio unit (RU) 170, a RAN Intelligent Controller (RIC) 175 (e.g., a Near-Real Time RIC (Near-RT RIC), a Non-Real Time RIC (Non-RT RIC)), a Service Management and Orchestration (SMO) 180 system, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, and any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaption protocol (SDAP), Packet Data Convergence Protocol (PDCP)). The CU 160 may be connected to one or more DUs 165 or RUs 170, and the one or more DUs 165 or RUs 170 may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or more RUs 170). In some cases, a functional split between a CU 160 and a DU 165, or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to one or more DUs 165 via a midhaul communication link 162 (e.g., F1, F1-c, F1-u), and a DU 165 may be connected to one or more RUs 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities 105 that are in communication via such communication links.

In wireless communications systems (e.g., wireless communications system 100), infrastructure and spectral resources for radio access may support wireless backhaul link capabilities to supplement wired backhaul connections, providing an IAB network architecture (e.g., to a core network 130). In some cases, in an IAB network, one or more network entities 105 (e.g., IAB nodes 104) may be partially controlled by each other. One or more IAB nodes 104 may be referred to as a donor entity or an IAB donor. One or more DUs 165 or one or more RUs 170 may be partially controlled by one or more CUs 160 associated with a donor network entity 105 (e.g., a donor base station 140). The one or more donor network entities 105 (e.g., IAB donors) may be in communication with one or more additional network entities 105 (e.g., IAB nodes 104) via supported access and backhaul links (e.g., backhaul communication links 120). IAB nodes 104 may include an IAB mobile termination (IAB-MT) controlled (e.g., scheduled) by DUs 165 of a coupled IAB donor. An IAB-MT may include an independent set of antennas for relay of communications with UEs 115, or may share the same antennas (e.g., of an RU 170) of an IAB node 104 used for access via the DU 165 of the IAB node 104 (e.g., referred to as virtual IAB-MT (vIAB-MT)). In some examples, the IAB nodes 104 may include DUs 165 that support communication links with additional entities (e.g., IAB nodes 104, UEs 115) within the relay chain or configuration of the access network (e.g., downstream). In such cases, one or more components of the disaggregated RAN architecture (e.g., one or more IAB nodes 104 or components of IAB nodes 104) may be configured to operate according to the techniques described herein.

In the case of the techniques described herein applied in the context of a disaggregated RAN architecture, one or more components of the disaggregated RAN architecture may be configured to support asynchronous uplink trigger design as described herein. For example, some operations described as being performed by a UE 115 or a network entity 105 (e.g., a base station 140) may additionally, or alternatively, be performed by one or more components of the disaggregated RAN architecture (e.g., IAB nodes 104, DUs 165, CUs 160, RUs 170, RIC 175, SMO 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via one or more communication links 125 (e.g., an access link) using resources associated with one or more carriers. The term “carrier” may refer to a set of RF spectrum resources having a defined physical layer structure for supporting the communication links 125. For example, a carrier used for a communication link 125 may include a portion of a RF spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities 105).

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (STTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

In some examples, a network entity 105 (e.g., a base station 140, an RU 170) may be movable and therefore provide communication coverage for a moving coverage area 110. In some examples, different coverage areas 110 associated with different technologies may overlap, but the different coverage areas 110 may be supported by the same network entity 105. In some other examples, the overlapping coverage areas 110 associated with different technologies may be supported by different network entities 105. The wireless communications system 100 may include, for example, a heterogeneous network in which different types of the network entities 105 provide coverage for various coverage areas 110 using the same or different radio access technologies.

The wireless communications system 100 may support synchronous or asynchronous operation. For synchronous operation, network entities 105 (e.g., base stations 140) may have similar frame timings, and transmissions from different network entities 105 may be approximately aligned in time. For asynchronous operation, network entities 105 may have different frame timings, and transmissions from different network entities 105 may, in some examples, not be aligned in time. The techniques described herein may be used for either synchronous or asynchronous operations.

Some UEs 115, such as MTC or IoT devices, may be low cost or low complexity devices and may provide for automated communication between machines (e.g., via Machine-to-Machine (M2M) communication). M2M communication or MTC may refer to data communication technologies that allow devices to communicate with one another or a network entity 105 (e.g., a base station 140) without human intervention. In some examples, M2M communication or MTC may include communications from devices that integrate sensors or meters to measure or capture information and relay such information to a central server or application program that uses the information or presents the information to humans interacting with the application program. Some UEs 115 may be designed to collect information or enable automated behavior of machines or other devices. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging.

Some UEs 115 may be configured to employ operating modes that reduce power consumption, such as half-duplex communications (e.g., a mode that supports one-way communication via transmission or reception, but not transmission and reception concurrently). In some examples, half-duplex communications may be performed at a reduced peak rate. Other power conservation techniques for the UEs 115 include entering a power saving deep sleep mode when not engaging in active communications, operating using a limited bandwidth (e.g., according to narrowband communications), or a combination of these techniques. For example, some UEs 115 may be configured for operation using a narrowband protocol type that is associated with a defined portion or range (e.g., set of subcarriers or resource blocks (RBs)) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs 115 via a device-to-device (D2D) communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1: M) system in which each UE 115 transmits to each of the other UEs 115 in the group. In some examples, a network entity 105 may facilitate the scheduling of resources for D2D communications. In some other examples, D2D communications may be carried out between the UEs 115 without an involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than 100 kilometers) compared to communications using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) radio access technology, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

The UEs 115 and the network entities 105 may support retransmissions of data to increase the likelihood that data is received successfully. Hybrid automatic repeat request (HARQ) feedback is one technique for increasing the likelihood that data is received correctly via a communication link (e.g., a communication link 125, a D2D communication link 135). HARQ may include a combination of error detection (e.g., using a cyclic redundancy check (CRC)), forward error correction (FEC), and retransmission (e.g., automatic repeat request (ARQ)). HARQ may improve throughput at the MAC layer in poor radio conditions (e.g., low signal-to-noise conditions). In some examples, a device may support same-slot HARQ feedback, in which case the device may provide HARQ feedback in a specific slot for data received via a previous symbol in the slot. In some other examples, the device may provide HARQ feedback in a subsequent slot, or according to some other time interval.

The wireless communications system 200 may support transmission of asynchronous uplink trigger. For example, a UE 115 may receive, from a network entity 105, an indication of parameters associated with an uplink trigger configuration, where the parameters are associated with ESRs, CSRs, or both. In some cases, the UE 115 may transmit, via a BR, an acknowledgment message indication reception of the parameters associated with the uplink trigger configuration. Additionally, the UE 115 may transmit, via an AR, an uplink trigger based on the uplink trigger configuration, where the uplink trigger includes the ESRs, CSRs, or both. In some cases, the UE 115 may transmit the uplink trigger according to one or more waveforms. For example, uplink trigger may be associated with a sequence-based waveform, a CSS-based waveform, a pre-configured waveform, or any combination thereof. The UE 115 may monitor, via the BR, for energy grants, communication grants, or both, based on the uplink trigger. In some cases, the monitoring may be based on the uplink trigger configuration, where the uplink trigger configuration indicates a duration associated with a monitoring window for the UE 115. In some cases, the UE 115 may receive, via the BR, the energy grants, the communication grants, or both. Alternatively, the UE 115 may fail to receive, via the BR, the energy grants, the communication grants, or both, and may transmit a retransmission of the uplink trigger.

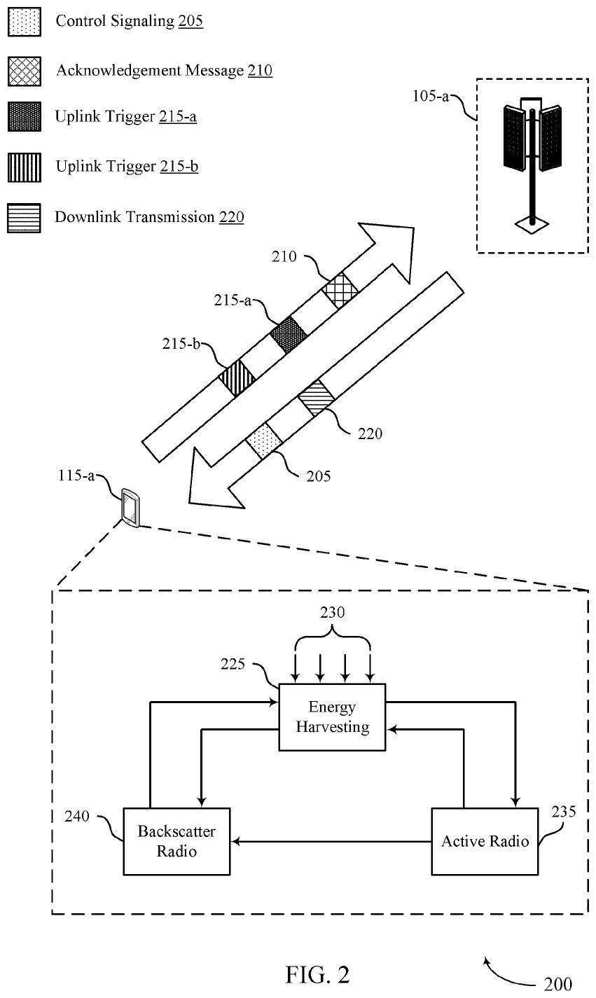

FIG. 2 illustrates an example of a wireless communications system 200 that supports asynchronous uplink trigger design in accordance with one or more aspects of the present disclosure. In some examples, the wireless communications system 200 may implement or be implemented by aspects of the wireless communications system 100. For example, the wireless communications system 200 may include one or more network entities 105 (e.g., a network entity 105-a) and one or more UEs 115 (e.g., a UE 115-a), which may be examples of the corresponding devices described herein with reference to FIG. 1. In the example of FIG. 2, the network entity 105-a may be examples of a CU 160, a DU 165, an RU 170, a base station 140, an IAB node 104, or one or more other network nodes as described herein with reference to FIG. 1. In some cases, the UE 115-a may support transmission of asynchronous uplink triggers.

In some cases, the wireless communications system 200 may support multiple device types. For example, a wireless device, such as the UE 115-a, may be classified as an enhanced mobile broadband (eMBB) device (i.e., 100 MHz, 1T4R, 2.3 Gbps), a reduced capability (RedCap) device (i.e., 20 MHZ, 1T1R/1T2R, 150 Mbps or 5/[1.4] MHz, 1T1R, 3 Mbps), an enhanced machine type communication (eMTC) category (Cat) M1 device (i.e., 1.4 MHZ, 1T1R, 1 Mbps), a narrowband internet of things (NB-IoT) Cat NB1 device (i.e., 180 kHz, 1T1R, 25 kbps), an ultra-light IoT device, a passive IoT device (i.e., 100 kHz, 1T1R, 100 kHz), or the like thereof. In some cases, each wireless device class may support a different level of coverage, such as a high coverage level (e.g., R16 eMBB) or a low coverage level (e.g., passive IoT). For example, a wireless device supporting a high coverage level may be associated with higher bandwidths, antenna, and peak rates compared to a wireless device supporting a low coverage level, which may be associated with lower bandwidths, antenna, and peak rates. In some examples, ultra-light IoT devices may be associated with low energy and low coverage while still including a battery.

In some examples, the UE 115-a may include an energy harvesting component 225, an AR component 235, and a BR component 240 (e.g., may be classified as an ultra-light IoT device). The energy harvesting component 225 may harvest energy 230 (e.g., ambient or dedicated energy signals, solar energy, etc.) from the environment or from an energy storage device, such as a battery, to support operation of the UE 115-a. In some examples, the energy harvesting component 225 may store energy 230 harvested from the environment in the energy storage device for future use. The BR component 240 may transmit information bearing signals (e.g., backscatter modulated information signals) based on receiving energy 230 from the energy harvesting component 225. That is, the energy harvesting component 225 may transmit energy 230 to the BR component 240 which the BR component 240 may reflect as (e.g., convert into) a communication signal (e.g., information bearing signal) to the network entity 105-a. In some cases, this may be referred to as reader-initiated communications (i.e., similar to passive device classes). Similarly, the AR component 235 may transmit communications based on receiving energy 230 from the energy harvesting component 225. That is, the energy harvesting component 225 may transmit energy 230 to the AR component 240 and the AR component 240 may use the energy 230 to generate a signal (e.g., active signal generation). In some cases, this may be referred to as tag-initiated communications.

In some examples, the signal generated by the AR component 240 may be an uplink trigger 215. An uplink trigger 215 may include one or more CSRs, one or more ESRs, or both. In some cases, the UE 115-a may transmit a CSR via the AR component 240 based on the UE 115-a operating in a low energy state (e.g., the UE 115-a may request an energy signal for additional power). Additionally, or alternatively, the UE 115-a may transit an ESR via the AR component 240 based on the UE 115-a having available (e.g., to transmit) to the network entity 105-a (e.g., via the BR component 235). That is, the AR component 235 may transmit one or more ESRs, CSRs, or both, to initiate communication scheduling (e.g., via a communication grant), energy scheduling (e.g., via an energy grant), or both (e.g., with the BR component 240).

In some cases, the UE 115-a may support active signal generation (i.e., due to cost or power requirements), coarse synchronous or asynchronous communications, no power amplifier or low-noise amplifier (i.e., such that operations may exist at or below 5 dBm), low complexity and low-power waveforms, a light protocol stack, or any combination thereof (e.g., to operate as an ultra-light IoT device). Additionally, or alternatively, the UE 115-a may balance one or more factors (e.g., cost, power, functionality, etc.) based on operation of the energy harvesting component 225, the AR component 235, and the BR component 240 (e.g., an operational sweet spot).

In some examples, the active radio component 235, the backscatter radio component 240, or both may operate synchronously. That is, the UE 115-a may receive, from the network entity 105-a, an indication of one or more time resources (e.g., pre-configured time resources) at which the UE 115-a may transmit one or more signals via the BR component 240, the AR component 235, or both. Additionally, or alternatively, the AR component 235, the BR component 240, or both, may operate asynchronously. That is, the UE 115-a may not receive an indication of one or more time resources (e.g., pre-configured time resources) at which the UE 115-a may transmit one or more signals via the BR component 240, the AR component 235, or both. In such examples, the AR component 235 may transmit the uplink trigger 25 in an asynchronous manner (e.g., not according to pre-configured timing). That is, the AR component 235 may transmit the uplink trigger 215 without performing a synchronization procedure (e.g., resulting in power saving). However, the UE 115-a may experience frequency errors associated with the asynchronous transmission of the uplink trigger 215.

In some cases, the AR component 235 and the BR component 240 may operate in different frequency bands (e.g., standalone frequency bands). In some examples, the AR component 235 may operate in asynchronously in a first frequency band while the BR component 240 may operate synchronously in a second frequency band. Alternatively, the AR component 235 may operate synchronously in the first frequency band while the BR component 240 may operate asynchronously in the second frequency band. In some examples, the AR component 235 and the BR component 240 may both operate synchronously or asynchronously in different frequency bands.

In some examples, the AR component 235 and the BR component 240 may operate in a same frequency band (e.g., standalone frequency band). In such examples, the AR component 235 and the BR component 240 may both operate either synchronously or asynchronously (e.g., simultaneously) in a shared frequency band.

Additionally, or alternatively, the AR component 235 and the BR component 240 may coexist with a new radio (NR) frequency band(s). That is, the AR component 235 and the BR component 240 may operate in different frequency bands (i.e., separately deployed) or the same frequency band (i.e., jointly deployed), where the NR frequency band(s) is different than the one or more frequency bands associated with the AR component 235, the BR component 240, or both. In some cases, the AR component 235, the BR component 240, or both, may include physical resource blocks (PRBs) (i.e., NR PRBs) or guard bands (e.g., NR guard bands).

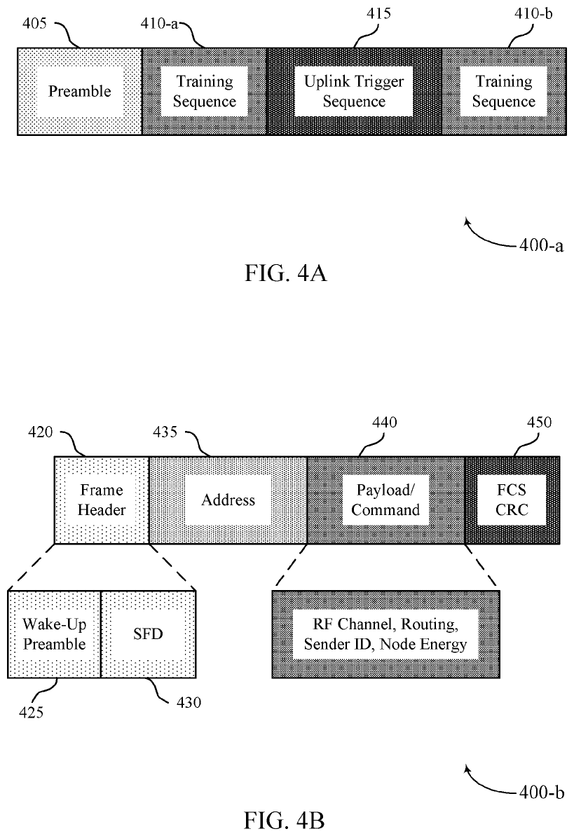

The wireless communications system 200 may support transmission of asynchronous uplink triggers according to the techniques described herein. For example, the network entity 105-a may transmit control signaling 205 to the UE 115-a (e.g., received via the BR component 240) indicating parameters associated with an uplink trigger configuration. The parameters associated with the uplink trigger 215 may indicate one or more waveforms associated with the uplink trigger 215. For example, the uplink trigger 215 may be associated with one or more sequence-based waveform, one or more chirp spreading spectrum (CSS) based waveforms, one or more pre-configured waveforms, or any combination thereof, as described with reference to FIG. 4. In some cases, the UE 115-a may transmit (e.g., via the BR component 240) an acknowledgment message 210 in response to the control signaling 205. Additionally, or alternatively, the UE 115-a may transmit (e.g., via the AR component 235) an uplink trigger 215-a, including one or more CSRs, one or more CSRs, or both, according to the uplink trigger configuration. Further, the UE 115-a may monitor (e.g., via the BR component 240) for a downlink transmission 220 (e.g., a query-msg) during a monitoring window (e.g., pre-configured monitoring window) based on the control signaling 205 and the uplink trigger 215-a. In some cases, the monitoring window may be based on the uplink trigger configuration. The downlink transmission 220 may include energy grants, communication grants, or both. In some cases, the UE 115-a may receive the downlink transmission 220 based on the uplink trigger 215-a. Alternatively, the UE 115-a may fail to receive the downlink transmission 220 based on the uplink trigger 215-a (e.g., the network entity 105-a may not transmit the downlink transmission 220 based on the uplink trigger 215-a) such that the UE 115-a may transmit an uplink trigger 215-b, which may be a retransmission of the uplink trigger 215-a. In some cases, the UE 115-a may receive the downlink transmission 220 based on the uplink trigger 215-b.

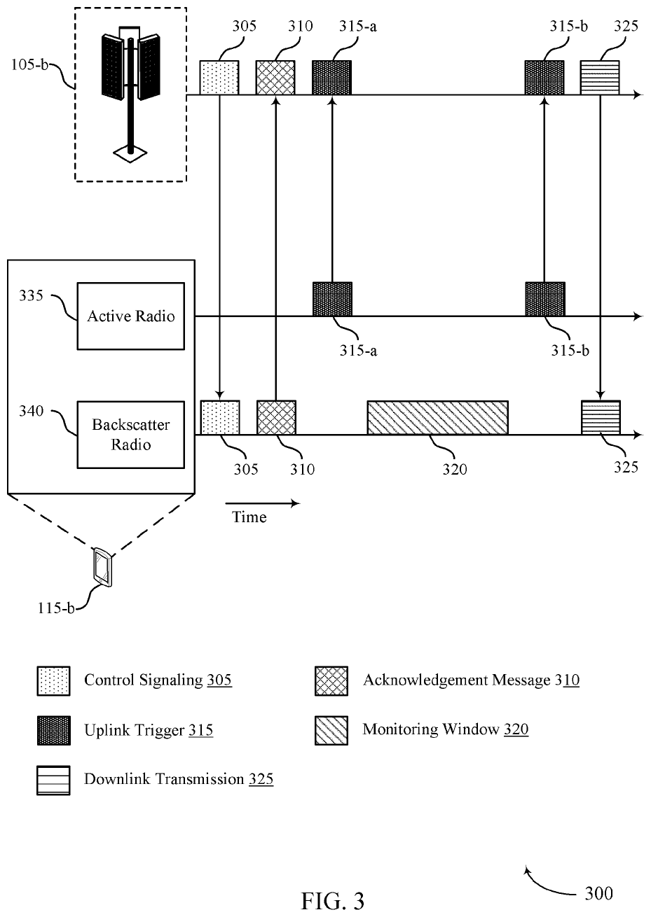

FIG. 3 illustrates an example of an uplink trigger procedure 300 that supports asynchronous uplink trigger design in accordance with one or more aspects of the present disclosure. In some examples, the uplink trigger procedure 300 may implement or be implemented by aspects of the wireless communications system 100 and the wireless communications system 200. For example, the uplink trigger procedure 300 may include one or more network entities 105 (e.g., a network entity 105-b) and one or more UEs 115 (e.g., a UE 115-b), which may be examples of the corresponding devices described herein with reference to FIG. 1. In the example of FIG. 3, the network entity 105-b may be examples of a CU 160, a DU 165, an RU 170, a base station 140, an IAB node 104, or one or more other network nodes as described herein with reference to FIG. 1. In some cases, the UE 115-b may support transmission of asynchronous uplink triggers.

The UE 115-b may receive, via a BR component 340 (e.g., which may be an example of the AR component 240 described with reference to FIG. 2), control signaling 305 (e.g., one or more control messages) indicating parameters (e.g., one or more parameters) associated with an uplink trigger configuration. For example, the control signaling 305 may indicate one or more parameters associated with one or more CSRs, one or more parameters associated with one or more ESRs, or both. Additionally, or alternatively, the control signaling 305 may indicate parameters associated with a duration of a monitoring window 320 (e.g., BR monitoring window), uplink trigger 315 repetition, uplink trigger 315 retransmission, or a combination thereof.

In some examples, the UE 115-b may transmit, via the BR component 340, an acknowledgment message 310 to the network entity 105-b based on the control signaling 305. In such examples, the acknowledgment message 310 may indicate reception of the parameters associated with the uplink trigger configuration (i.e., reception of the control signaling 305).

Additionally, the UE 115-b may transmit, via the AR component 335, an uplink trigger 315-a based on the control signaling 305. That is, the UE 115-b may determine an uplink trigger 315 transmission opportunity (e.g., ULTO-TO) based on control signaling 305. In such examples, the uplink trigger 315-a may include the one or more CSRs, the one or more ESRs, or both. In some cases, the uplink trigger 315-a may include an indication of a UE group associated with the UE 115-b, a UE identifier associated with the UE 115-b, a cell group associated with the UE 115-b, a cell identifier of the cell group associated with the UE 115-b, a scheduling request type (e.g., ESR, CSR, or both), or any combination thereof. Additionally, the UE 115-b may transmit the uplink trigger 315-a according to one or more waveforms associated with the one or more CSRs, one or more ESRs, or both, described with reference to FIGS. 4A and 4B.

In some examples, the UE 115-b may monitor, via the BR component 340, for a downlink transmission 325 including one or more energy grants, one or more communication grants, or both, (e.g., based on the uplink trigger 315-a) during the monitoring window 320 (e.g., pre-configured monitoring window 320). The monitoring window 320 may be based on the duration indicated in the control signaling 305

In some cases, the network entity 105-b may transmit the downlink transmission 325 based on receiving the uplink trigger 315-a (e.g., not shown). Alternatively, as shown in FIG. 3, the UE 115-b may fail to receive the downlink transmission 325 during the monitoring window 320 and may transmit the uplink trigger 315-b based on failing to receive the downlink transmission 325 during the monitoring window 320. The uplink trigger 315-b may be a retransmission of the uplink trigger 315-a. That is, the uplink trigger 315-b may include the same CSRs, ESRs, or both, as the uplink trigger 315-a. In some cases, the network entity 105-b may transmit the downlink transmission 325 based on receiving the uplink trigger 315-b.

In some cases, the UE 115-b may receive, from the network entity 105-b, control signaling 305 indicating a duty cycle configuration associated with transmission of the uplink trigger 315. In other words, the UE 115-b (e.g., UE 115-b MAC) may receive, via the BR component 340 (e.g., BR physical layer), the control signaling 305 indicating the duty cycle configuration. In some cases, the duty cycle configuration and the uplink trigger configuration may be indicated in the same control signaling 305 or different control signaling 305. As such, the UE 115-b may transmit the uplink trigger 315 in accordance with the duty cycle configuration (e.g., duty cycle configuration of AR physical layer). In some cases, the duty cycle configuration may indicate for the UE 115-b to refrain from transmitting an uplink trigger 315 based on a congestion level (e.g., of a frequency band associated with the uplink trigger 315). That is, the UE 115-b may disable transmission of uplink triggers 315 (e.g., for a duration) based on the congestion level exceeding a threshold. Additionally, or alternatively, the duty cycle configuration may indicate a threshold quantity of uplink triggers 315 that the UE 115-b may transmit within a threshold duration (e.g., X uplink triggers 315 in Y ms). In such cases, the threshold quantity of uplink triggers, the threshold duration, or both, may be based on a scheduling request type (e.g., CSR, ESR, or both), a priority, or both. Additionally, or alternatively, the duty cycle configuration may indicate one or more rules for transmission of uplink triggers 315 based on an energy state (e.g., ULTrate) of the UE 115-b, a power consumption of transmission of the uplink trigger 315, or both (e.g., ULTrate=energy remaining/ULTenergyconsumption). For example, the duty cycle configuration may indicate for the UE 115-b to refrain from transmitting uplink triggers 315 (e.g., for low priority CSRs, ESRs, or both) based on an energy state (e.g., ULTrate) of the UE 115-b being below a threshold. Additionally, or alternatively, the duty cycle configuration may indicate for the UE 115-b to transmit ESRs and refrain from transmitting CSRs based on an energy state (e.g., ULTrate) of the UE 115-b being below a threshold.

In some cases, the UE 115-b may transmit, to the network entity 105-b, a report indicating one or more energy consumptions (e.g., energy consumption levels) associated with transmitting an uplink trigger 315 at different transmit powers, a recommended duty cycle configuration (E.g., based on an energy state of the UE 115-b), or both. As such, the network entity 105-b may modify the duty cycle configuration based on the indication from the UE 115-b. For example, the network entity 105-b may transmit control signaling 305 indicating an increase or a decrease of a duration of a duty cycle of the UE 115-b based on a congestion level (e.g., of the frequency band associated with the uplink trigger 315).

FIGS. 4A and 4B each illustrates an example of an uplink trigger format 400 (e.g., an uplink trigger format 400-a and an uplink trigger format 400-b) that supports asynchronous uplink trigger design in accordance with one or more aspects of the present disclosure. In some examples, the uplink trigger formats 400 may implement or be implemented by aspects of the wireless communications system 100, the wireless communications system 200, and the uplink trigger procedure 300. For example, the uplink trigger formats 400 may be implemented by one or more network entities 105 and one or more UEs 115, which may be examples of the corresponding devices described herein with reference to FIG. 1. In some cases, the uplink trigger format 400 may support transmission of asynchronous uplink triggers.

In some cases, a UE 115 may transmit one or more uplink triggers according to one or more waveforms. That is, a network entity 105 may indicate the one or more waveforms to the UE 115 (e.g., via one or more uplink trigger configurations) and the UE 115 may transmit one or more uplink triggers using the one or more indicated waveforms.

In some cases, the one or more waveforms may be sequence-base waveforms (e.g., the uplink trigger may be associated with one or more sequency-based waveforms). For example, the network entity 105 may transmit an indication of one or more (e.g., a pool of) uplink trigger sequences 415 (e.g., wₘ(k)) associated with one or more uplink triggers. In some cases, a first set of uplink trigger sequences 415 may be associated with ESRs while a second set of uplink trigger sequences 415 may be associated with CSRs. That is, a given uplink trigger sequence 415 may indicate an ESR, a CSR, or both. Additionally, or alternatively, a given uplink trigger sequence 415 may indicate a priority (e.g., of traffic or urgency) of a scheduling request (e.g., ESR, CSR, or both).

In some examples, the network entity 105 may transmit an indication of one or more uplink trigger sequences 415 associated with one or more uplink triggers to more than one UE 115. For example, a first UE 115 and a second UE 115 may transmit uplink triggers according to the one or more uplink trigger sequence 415 (e.g., same uplink trigger sequences 415 may be shared by the first UE 115 and the second UE 115). Additionally, or alternatively, a group of UEs 115 (e.g., UE 115 group) may be FDM'ed or CDM'ed. That is, different UEs 115 may transmit uplink triggers in different subchannels, may scramble each uplink trigger sequence 415 by different pseudo-random codes, or both.

In some cases, the one or more uplink trigger sequences 415 may be of low auto-correlation, low cross-correlation, or both. For example, the one or more uplink trigger sequences 415 may be m-sequences, Gold sequences, Zadoff-Chu (ZC) sequences, Barker sequences, or the like thereof. In some cases, a UE 115 may generate the one or more uplink trigger sequences 415 based on a UE identifier associated with the UE 115, a cell identifier associated with the UE 115, or both. For example, the UE 115 may determine a polynomial m-sequence for generation or an initial value of a polynomial shift register based on the UE identifier, the cell identifier, and a scheduling request type of an uplink trigger.

In some cases, the UE 115 may generate (e.g., compute) the uplink trigger sequences 415 (e.g., low-power sequence-based waveform) according to the following Equation 1:

$${w}_{m} ( k ) = θ ( m ) \cdot {w}_{m}^{′} ( k ) \qquad ( 1 )$$

where the parameter wₘ(k) may represent the generated uplink trigger sequence 415, the parameter θ(m) may represent a scrambling sequence indicated (e.g., configured) by a network entity 105, and the parameter wₘ′(k) may represent an uplink trigger sequence 415 indicated (e.g., configured) by the network entity 105. In some cases, θ(m) may be a function of a physical cell identifier associated with the UE 115. Additionally, or alternatively, the generated uplink trigger sequence 415 may be time-varying (e.g., for interference randomization). That is, θ(m) may be a function of SFN (e.g., slot index at a time of transmission of the uplink trigger sequence 415). In some cases, AR may be asynchronous and BR may be synchronous, such that the SFN (e.g., slot index) may be based on the BR. In some other cases, the BR may be associated (e.g., configure) a counter associated with the SFN or the SFN may be based on the AR.

Additionally, or alternatively, the uplink trigger sequence 415 may be preceded by one or more training sequences 410, such as a training sequence 410-a, may be followed by one or more training sequences 410, such as a training sequence 410-b, or both. In such cases, a network entity 105 receiving the transmission including the uplink trigger sequence 415 may estimate a carrier frequency offset (CFO), sampling time offset (STO), a channel, an IQ-imbalance, or the like thereof associated with the UE 115 (e.g., for more reliable uplink trigger sequence 415 detection). Additionally, or alternatively, the uplink trigger sequence 415 may be preceded with a preamble 405 such that the network entity 105 may detect the preamble 405 prior to (e.g., before) detecting the uplink trigger sequence 415.

In some cases, the UE 115 may transmit (e.g., repeat) a quantity (e.g., number) of uplink trigger transmissions (e.g., in a consecutive manner). That is, the UE 115 may transmit a quantity of uplink trigger repetitions. In some cases, the quantity (e.g., X) of uplink trigger repetitions may be based on a coverage level of the UE 115 (e.g., as configured by a network entity 105). That is, a first quantity of uplink trigger repetitions (e.g., X₁) may be associated with a first coverage level, a second quantity of uplink trigger repetitions (e.g., X₂) may be associated with a second coverage level, and a third quantity of uplink trigger repetitions (e.g., X₃) may be associated with a third coverage level. In some cases, the UE 115 may determine a coverage level based on a reference signal receive power (RSRP) (e.g., the coverage level may be defined based on RSRP). That is, the UE 115 may measure a RSRP of one or more reference signals (e.g., received via the BR) and may compare the RSRP to one or more thresholds. For example, the first coverage level may be associated with RSRP values less than (e.g., failing to exceed) a first threshold, the second coverage level may be associated with RSRP values greater than (e.g., exceeding) the first threshold but less than a second threshold, and the third coverage level may be associated with RSRP values greater than the second threshold. The network entity 105 may transmit, to the UE 115, an indication of the one or more thresholds (e.g., the network entity 105 may configure the one or more thresholds). Additionally, or alternatively, the UE 115 may be associated with a threshold (e.g., maximum) quantity of uplink trigger repetitions (e.g., Xₘₐₓ may be configured for cell-edge UEs 115).

In some cases, the UE 115 may indicate, to the network entity 105, whether multiple uplink trigger repetitions may be combined (e.g., coherently combined). That is, the network entity 105 may combine two or more uplink trigger repetition transmissions to obtain a combined uplink trigger repetition associated with a higher transmit power and a higher beam quality (e.g., than a single uplink trigger repetition transmission). Additionally, or alternatively, the UE 115 may indicate (e.g., to the network entity 105) whether the UE 115 is capable of repeating an uplink trigger in a time domain, a frequency domain, on multiple antennas, or any combination thereof. That is, the UE 115 may transmit multiple uplink trigger repetitions using different resources in the time domain, using different resources in the frequency domain, using different antennas, or any combination thereof (e.g., to achieve time, frequency, or antenna diversity). Additionally, or alternatively, different uplink trigger sequences 415 may be associated with different quantities of uplink trigger repetitions.

In some cases, the UE 115 may select a quantity of uplink trigger repetitions based on the coverage level of the UE 115, one or more signal measurements (e.g., RSRP measurements), a priority associated with the uplink trigger, monitoring for a downlink transmission based on the uplink trigger, or any combination thereof. For example, the UE 115 may increase a quantity of uplink trigger repetitions based on not receiving a downlink transmission in response to the uplink trigger (e.g., in a monitoring window). That is, the UE 115 may select a first quantity of repetitions for a first uplink trigger transmission (e.g., uplink trigger attempt), a second quantity of repetitions for a second uplink trigger, and so on until the threshold (e.g., maximum) quantity of uplink trigger repetitions are reached. In some other examples, (e.g., for a high priority transmission) the UE 115 may select a higher quantity of repetitions for the first uplink trigger transmission (e.g., based on signal measurements such as RSRP).

In some examples, the network entity 105 may detect one or more of the uplink trigger sequences 415 associated with the uplink trigger from a set of uplink trigger sequences 415 based at least in part on an identifier associated with the UE 115. That is, the network entity may map uplink trigger sequences 415 to identifiers associated with UEs 115. In such cases, the mapping may be based on look-up table. Additionally, or alternatively, the mapping may be based on a function rule between the identifier associated with the UE 115 and the uplink trigger sequence 415 (e.g., polynomial and initial value of polynomial shift register).

In some cases, the network entity may detect one or more of the uplink trigger sequences 415 associated with the uplink trigger from a set of uplink trigger sequences 415 and search for the set of uplink trigger sequences 415 based at least in part on detecting the preamble 405. In such cases, detecting the one or more uplink trigger sequences 415 from the set of uplink trigger sequences 415 may be based on the searching.

In some cases, the network entity 105 may correlate (e.g., perform correlation between) the uplink trigger sequence 415 and energy detection for maintaining uplink trigger sequence 415 detection performance tradeoff between missed detections and false alarms. In some cases, the network entity 105 may estimate a frequency offset and channel associated with the uplink trigger sequence 415 to support (e.g., refine) uplink trigger sequence 415 detection.

In some cases, (e.g., if a sequence is shared by a quantity of UEs 115) the network entity 105 may trigger a contention resolution procedure (e.g., via the BR). That is, the network entity 105 may query all the UEs 115 sharing an uplink trigger sequence 415.

In some cases, the network entity 105 may configure an uplink trigger sequences 415 and repetitions of the uplink trigger sequence 415 via the BR. As such, the network entity 105 may disable one or more uplink trigger sequences 415, may configure one or more uplink trigger sequences 415 (e.g., new uplink trigger sequences 415), or both. Additionally, or alternatively, the network entity 105 may indicate to the UE 115 to increase or decrease a quantity of uplink trigger repetitions, to include training sequences 410 (e.g., for CFO, STO, and channel estimation (CE)), increase or decrease a transmit power for an uplink trigger, or any combination thereof.

In some cases, the one or more waveforms may be associated with one or more chirps (e.g., CSS-based waveform). In such cases, a first set of chirps from the one or more chirps may be associated with ESRs and a second set of chirps from the one or more chirps may be associated with the CSRs. That is, the network entity 105 may determine (e.g., differentiate) a UE 115 transmitting an uplink trigger and a scheduling request type associated with the uplink trigger based on UEs 115 and scheduling request types being associated with different chirps. Additionally, or alternatively, CSS-based waveforms may be associated with low transmitter complexity with a simple frequency-shift keying (FSK) modulator.

In some cases, the UE 115 may be assigned a set of chirps with different spreading factors (SF). In such cases, the set of chirps with different SFs may be quasi-orthogonal. Additionally, or alternatively, large SF chirps may be associated with UEs 115 located at distances further away from the network entity 105 than UEs 115 located at distances closer to the network entity 105 (e.g., with small SF chips)

In some cases, the UE 115 may be assigned a set of chirps with a same SF but a different starting frequency. In such cases, the UE 115 may choose from 2^{SF} different starting frequencies. Additionally, or alternatively, the 2^{SF} starting frequencies (e.g., codes) may be assigned to users. In such cases, the UEs 115 may use a subset of the codes to account for frequency shifts (e.g., according to Doppler effects or CFO) so that adjacent frequency shifts may be avoided. In some cases, the uplink trigger transmission may include a preamble with a set of chirps (e.g., upchirps and down-chirps), allowing the network entity 105 to perform CFO and STO estimation and corrections.

In some examples, the UE 115 may transmit one or more uplink triggers according to a pre-configured waveform. That is, the UE 115 may receive (i.e., in the indication of the parameters associated with the uplink trigger configuration), an indication of a format associated with the one or more uplink triggers. In some cases, the format may include a frame header 420 (e.g., 1 byte), an address 435 (e.g., 2 bytes), a payload/command 440 (e.g., 2 bytes), a frame checking sequence (FCS) and a cyclic redundancy check (CRC) 450, or any combination thereof. In such cases, the frame header 420 may include a wake-up preamble 425 (e.g., for frame detection, automatic gain control (AGC), CE, coarse CFO, timing, etc.) and a start frame delimiter (SFD) 430 (e.g., for byte-level synchronization). Additionally, or alternatively, the address 435 may include the cell ID, the UE 115 ID, or both. Further, the payload/command 440 may indicate one or more of an RF channel, routing, sender ID, and a node energy (i.e., the payload/command 440 may indicate a scheduling request type, a buffer status report, etc.). Additionally, or alternatively, the uplink trigger transmission may include a training sequence (e.g., for refined CFO, STO, and channel estimation). In some cases, the uplink trigger transmission may support different forward error correction (FEC) coding rates such that low encoding complexity may exist at the UE 115 (e.g., simple block codes, LDGM, convolutional codes, etc.).

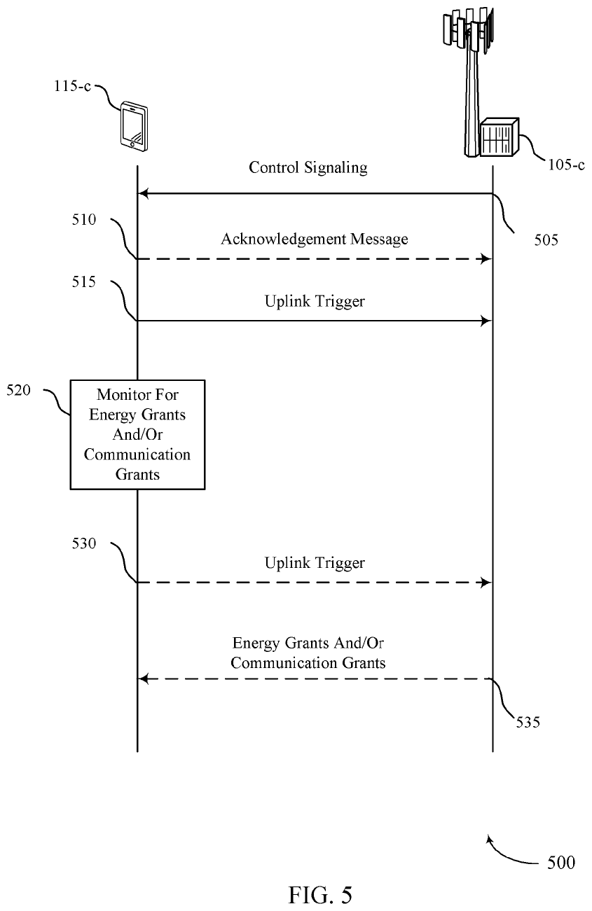

FIG. 5 illustrates an example of a process flow 500 that supports asynchronous uplink trigger design in accordance with one or more aspects of the present disclosure. In some examples, the process flow 500 may implement or be implemented by aspects of the wireless communications system 100, the wireless communications system 200, the uplink trigger procedure 300, and the uplink trigger formats 400. For example, the process flow 500 may include one or more network entities 105 (e.g., a network entity 105-c) and one or more UEs 115 (e.g., a UE 115-c), which may be examples of the corresponding devices described herein with reference to FIG. 1. In the example of FIG. 5, the network entity 105-c may be examples of a CU 160, a DU 165, an RU 170, a base station 140, an IAB node 104, or one or more other network nodes as described herein with reference to FIG. 1. In some cases, the UE 115-c may support transmission of asynchronous uplink triggers.

At 505, the UE 115-c may receive, from a network entity 105-c, an indication of parameters associated with an uplink trigger configuration, where the parameters are associated with ESRs, CSRs, or both. In some cases, the parameters associated with the ESRs, CSRs, or both, may include a first parameter associated with a duration of a monitoring window.

In some cases, the UE 115-c may receive, from a network entity 105-c, an indication of a first quantity of repetitions, a second quantity of repetitions, a third quantity of repetitions, a set of thresholds, or any combination thereof associated with a quantity of repetitions of an uplink trigger. In such cases, the quantity of repetitions may be associated with a coverage level of the UE 115-c. That is, the UE 115-c may measure a RSRP of one or more reference signal transmissions received a BR and may determine the coverage level of the UE 115-c based on the RSRP of the one or more reference signal transmissions.

In some cases, the UE 115-c may receive (i.e., in the indication of the parameters associated with the uplink trigger) an indication of one or more waveforms associated with transmission of the uplink trigger (e.g., via the indicated parameters associated with the uplink trigger configuration). Further, the one or more waveforms may be associated with one or more uplink trigger sequences. In some examples, a first set of uplink trigger sequences from the one or more uplink trigger sequences may be associated with the ESRs and a second set of uplink trigger sequences from the one or more uplink trigger sequences may be associated with the CSRs. In such cases, the UE 115-c may generate the first set of uplink trigger sequences and the second set of uplink trigger sequences based on a UE 115-c identifier, a cell identifier associated with the UE 115-c, or both.

In some cases, the indication of the parameters associated with the uplink trigger configuration may include an indication of a scrambling sequence, where the scrambling sequence is based on an identifier associated with the network entity 105-c. In such cases, the UE 115-c may generate the one or more uplink trigger sequences based on the scrambling sequence. In some cases, the scrambling sequence may be based on a system frame number, a slot index, a counter, or any combination thereof. In some cases, each of the one or more uplink trigger sequences may be preceded by a training sequence, followed by a training sequence, or both. In some cases, each of the one or more uplink trigger sequences may be associated with a preamble.

In some cases, the one or more waveforms may be associated with one or more chirps, and a first set of chirps from the one or more chirps may be associated with the ESRs and a second set of chirps from the one or more chirps may be associated with the CSRs.

In some cases, the indication of the parameters associated with the uplink trigger configuration may include an indication of a format associated with the uplink trigger, where the format includes a header, an address, an indication of the ESRs, CSRs, or both (e.g., an indication of a scheduling request type), a CRC, a training sequence, or any combination thereof.

In some cases, the control signaling may indicate a duty cycle configuration associated with transmission of the uplink trigger. In such cases, the duty cycle configuration may be based at least in part on a congestion level, a priority associated with the energy scheduling requests, a priority associated with the communication scheduling requests, an energy state of the UE, a power consumption associated with the transmission of the uplink trigger. Additionally, or alternatively, the UE 115-c may transmit, to the network entity 105-c, a report including an indication of one or more energy consumptions associated with the transmission of the uplink trigger at different transmit power levels, a recommended duty cycle configuration, or both, wherein the indicated duty cycle configuration is based at least in part on the report.

In some cases, at 510, the UE 115-c may transmit, via the BR, an acknowledgment message indicating reception of the parameters associated with the uplink trigger configuration.

At 515, the UE 115-c may transmit, via an AR, the uplink trigger based on the uplink trigger configuration (e.g., and according to the duty cycle configuration), where the uplink trigger includes the ESRs, the CSRs, or both. In some cases, the uplink trigger may include an indication of a UE group associated with the UE 115-c, a UE identifier associated with the UE 115-c, a cell group associated with the UE 115-c, a cell identifier of the cell group associated with the UE 115-c, or any combination thereof.

At 520, the UE 115-c may monitor, via the BR, for energy grants based on the uplink trigger, where the monitoring is based on the uplink trigger configuration (e.g., the duration of the monitoring window). Additionally, or alternatively, the UE 115-c may monitor, via the BR, for communication grants based on the uplink trigger, where the monitoring is based on the uplink trigger configuration.

In some cases, at 530, the UE 115-c may transmit, via the AR, a retransmission of the uplink trigger, based on failing to receive, via the BR, the energy grants, the communication grants, or both. In some cases, the UE 115-c may transmit the quantity of repetitions of the uplink trigger, wherein the quantity of repetitions is based on THE coverage level of the UE, one or more signal measurements, a priority associated with the uplink trigger, the monitoring, or any combination thereof. In such cases, a first coverage level of the UE 115-c may be associated with a first quantity of repetitions, a second coverage level of the UE 115-c may be associated with a second quantity of repetitions, and a third coverage level of the UE 115-c may be associated with a third quantity of repetitions. In such cases, transmitting the quantity of repetitions of the uplink trigger may include transmitting the first quantity of repetitions, the second quantity of repetitions, or the third quantity of repetitions based on a set of thresholds associated with the first coverage level, the second coverage level, the third coverage level, or any combination thereof.

At 535, the UE 115-c may receive, via the BR, the energy grants, the communication grants, or both, based on the monitoring.

In the description of the process flow 500, the operations may be performed (for example, reported or provided) in a different order than the order shown. Specific operations also may be left out of the process flow 500, or other operations may be added to the process flow 500. Further, although some operations or signaling may be shown to occur at different times for discussion purposes, these operations may actually occur at the same time.

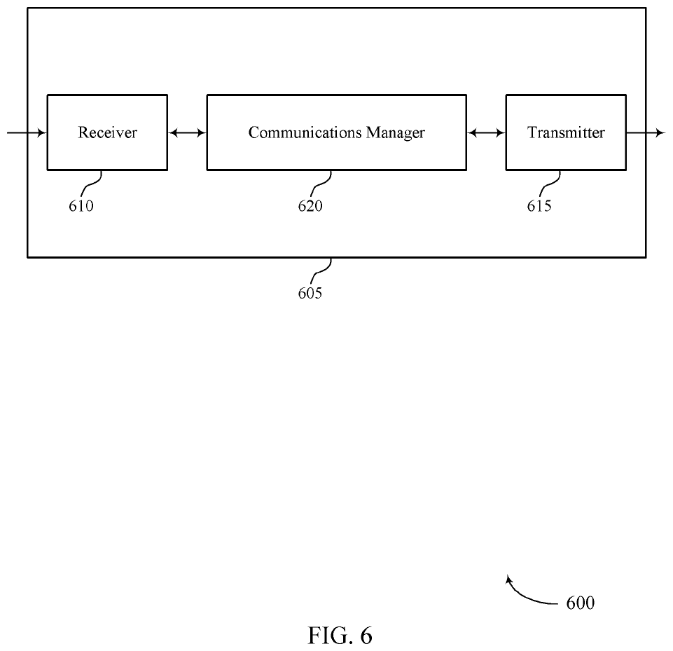

FIG. 6 shows a block diagram 600 of a device 605 that supports asynchronous uplink trigger design in accordance with one or more aspects of the present disclosure. The device 605 may be an example of aspects of a UE 115 as described herein. The device 605 may include a receiver 610, a transmitter 615, and a communications manager 620. The device 605 may also include a processor. Each of these components may be in communication with one another (e.g., via one or more buses).

The receiver 610 may provide a means for receiving information such as packets, user data, control information, or any combination thereof associated with various information channels (e.g., control channels, data channels, information channels related to asynchronous uplink trigger design). Information may be passed on to other components of the device 605. The receiver 610 may utilize a single antenna or a set of multiple antennas.

The transmitter 615 may provide a means for transmitting signals generated by other components of the device 605. For example, the transmitter 615 may transmit information such as packets, user data, control information, or any combination thereof associated with various information channels (e.g., control channels, data channels, information channels related to asynchronous uplink trigger design). In some examples, the transmitter 615 may be co-located with a receiver 610 in a transceiver module. The transmitter 615 may utilize a single antenna or a set of multiple antennas.

The communications manager 620, the receiver 610, the transmitter 615, or various combinations thereof or various components thereof may be examples of means for performing various aspects of asynchronous uplink trigger design as described herein. For example, the communications manager 620, the receiver 610, the transmitter 615, or various combinations or components thereof may support a method for performing one or more of the functions described herein.

In some examples, the communications manager 620, the receiver 610, the transmitter 615, or various combinations or components thereof may be implemented in hardware (e.g., in communications management circuitry). The hardware may include a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 620, the receiver 610, the transmitter 615, or various combinations or components thereof may be implemented in code (e.g., as communications management software or firmware) executed by a processor. If implemented in code executed by a processor, the functions of the communications manager 620, the receiver 610, the transmitter 615, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 620 may be configured to perform various operations (e.g., receiving, obtaining, monitoring, outputting, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to obtain information, output information, or perform various other operations as described herein.

The communications manager 620 may support wireless communications at a UE in accordance with examples as disclosed herein. For example, the communications manager 620 may be configured as or otherwise support a means for receiving, from a network entity, an indication of parameters associated with an uplink trigger configuration, where the parameters are associated with ESRs, CSRs, or both. The communications manager 620 may be configured as or otherwise support a means for transmitting, via an AR, an uplink trigger based on the uplink trigger configuration, where the uplink trigger includes the ESRs, the CSRs, or both. The communications manager 620 may be configured as or otherwise support a means for monitoring, via a BR, for energy grants, communication grants, or both, based on the uplink trigger, where the monitoring is based on the uplink trigger configuration.

By including or configuring the communications manager 620 in accordance with examples as described herein, the device 605 (e.g., a processor controlling or otherwise coupled with the receiver 610, the transmitter 615, the communications manager 620, or a combination thereof) may support techniques for asynchronous uplink trigger design which may result in reduced processing, reduced power consumption, and more efficient utilization of communication resources, among other advantages.

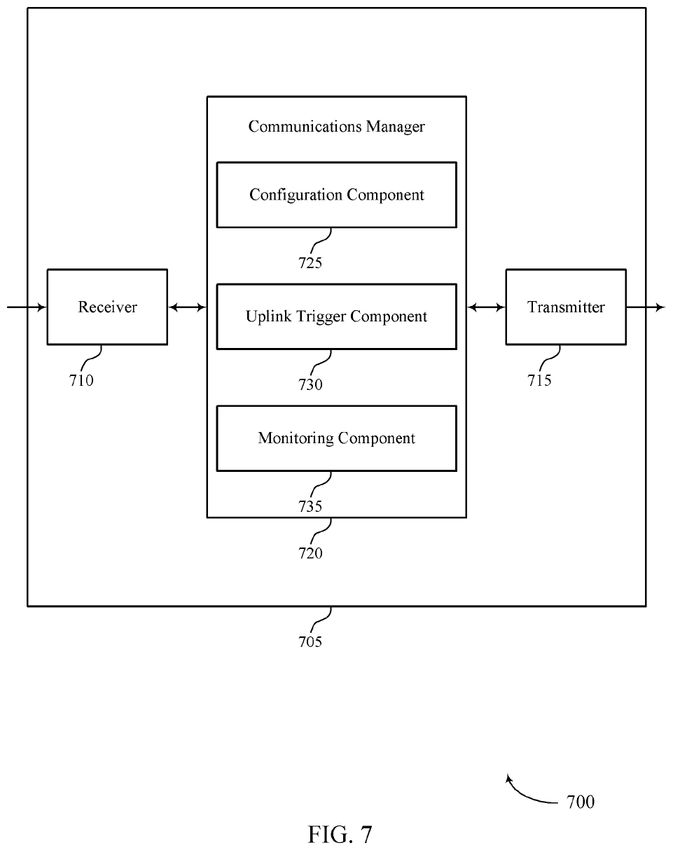

FIG. 7 shows a block diagram 700 of a device 705 that supports asynchronous uplink trigger design in accordance with one or more aspects of the present disclosure. The device 705 may be an example of aspects of a device 605 or a UE 115 as described herein. The device 705 may include a receiver 710, a transmitter 715, and a communications manager 720. The device 705 may also include a processor. Each of these components may be in communication with one another (e.g., via one or more buses).

The receiver 710 may provide a means for receiving information such as packets, user data, control information, or any combination thereof associated with various information channels (e.g., control channels, data channels, information channels related to asynchronous uplink trigger design). Information may be passed on to other components of the device 705. The receiver 710 may utilize a single antenna or a set of multiple antennas.

The transmitter 715 may provide a means for transmitting signals generated by other components of the device 705. For example, the transmitter 715 may transmit information such as packets, user data, control information, or any combination thereof associated with various information channels (e.g., control channels, data channels, information channels related to asynchronous uplink trigger design). In some examples, the transmitter 715 may be co-located with a receiver 710 in a transceiver module. The transmitter 715 may utilize a single antenna or a set of multiple antennas.

The device 705, or various components thereof, may be an example of means for performing various aspects of asynchronous uplink trigger design as described herein. For example, the communications manager 720 may include a configuration component 725, an uplink trigger component 730, a monitoring component 735, or any combination thereof. The communications manager 720 may be an example of aspects of a communications manager 620 as described herein. In some examples, the communications manager 720, or various components thereof, may be configured to perform various operations (e.g., receiving, obtaining, monitoring, outputting, transmitting) using or otherwise in cooperation with the receiver 710, the transmitter 715, or both. For example, the communications manager 720 may receive information from the receiver 710, send information to the transmitter 715, or be integrated in combination with the receiver 710, the transmitter 715, or both to obtain information, output information, or perform various other operations as described herein.

The communications manager 720 may support wireless communications at a UE in accordance with examples as disclosed herein. The configuration component 725 may be configured as or otherwise support a means for receiving, from a network entity, an indication of parameters associated with an uplink trigger configuration, where the parameters are associated with ESRs, CSRs, or both. The uplink trigger component 730 may be configured as or otherwise support a means for transmitting, via an AR, an uplink trigger based on the uplink trigger configuration, where the uplink trigger includes the ESRs, the CSRs, or both. The monitoring component 735 may be configured as or otherwise support a means for monitoring, via a BR, for energy grants, communication grants, or both, based on the uplink trigger, where the monitoring is based on the uplink trigger configuration.

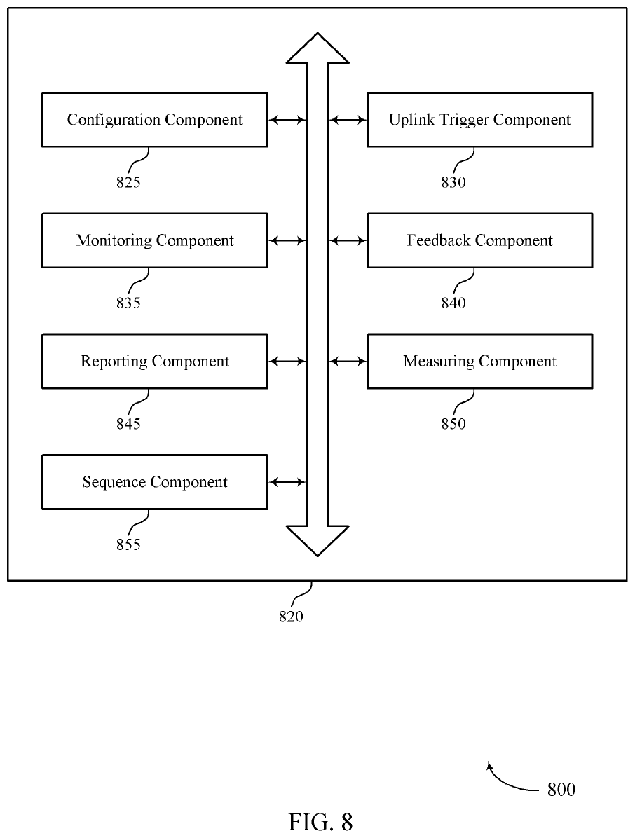

FIG. 8 shows a block diagram 800 of a communications manager 820 that supports asynchronous uplink trigger design in accordance with one or more aspects of the present disclosure. The communications manager 820 may be an example of aspects of a communications manager 620, a communications manager 720, or both, as described herein. The communications manager 820, or various components thereof, may be an example of means for performing various aspects of asynchronous uplink trigger design as described herein. For example, the communications manager 820 may include a configuration component 825, an uplink trigger component 830, a monitoring component 835, a feedback component 840, a reporting component 845, a measuring component 850, a sequence component 855, or any combination thereof. Each of these components may communicate, directly or indirectly, with one another (e.g., via one or more buses).

The communications manager 820 may support wireless communications at a UE in accordance with examples as disclosed herein. The configuration component 825 may be configured as or otherwise support a means for receiving, from a network entity, an indication of parameters associated with an uplink trigger configuration, where the parameters are associated with ESRs, CSRs, or both. The uplink trigger component 830 may be configured as or otherwise support a means for transmitting, via an AR, an uplink trigger based on the uplink trigger configuration, where the uplink trigger includes the ESRs, the CSRs, or both. The monitoring component 835 may be configured as or otherwise support a means for monitoring, via a BR, for energy grants, communication grants, or both, based on the uplink trigger, where the monitoring is based on the uplink trigger configuration.

In some examples, the monitoring component 835 may be configured as or otherwise support a means for receiving, via the BR, the energy grants, the communication grants, or both, based on the monitoring.

In some examples, the uplink trigger component 830 may be configured as or otherwise support a means for transmitting, via the AR, a retransmission of the uplink trigger, based on failing to receive, via the BR, the energy grants, the communication grants, or both.

In some examples, the feedback component 840 may be configured as or otherwise support a means for transmitting, via the BR, an acknowledgment message indicating reception of the parameters associated with the uplink trigger configuration.

In some examples, the uplink trigger component 830 may be configured as or otherwise support a means for transmitting a quantity of repetitions of the uplink trigger, where the quantity of repetitions is based on a coverage level of the UE, one or more signal measurements, a priority associated with the uplink trigger, the monitoring, or any combination thereof.

In some examples, to support transmitting a quantity of repetitions of the uplink trigger, the uplink trigger component 830 may be configured as or otherwise support a means for transmitting the first quantity of repetitions, the second quantity of repetitions, or the third quantity of repetitions based on a set of thresholds associated with the first coverage level, the second coverage level, the third coverage level, or any combination thereof.

In some examples, the configuration component 825 may be configured as or otherwise support a means for receiving, from the network entity, an indication of the first quantity of repetitions, the second quantity of repetitions, the third quantity of repetitions, the set of thresholds, or any combination thereof.

In some examples, the measuring component 850 may be configured as or otherwise support a means for measuring a reference signal receive power of one or more reference signal transmissions received via the BR. In some examples, the measuring component 850 may be configured as or otherwise support a means for determining the coverage level of the UE based on the reference signal receive power of the one or more reference signal transmissions.

In some examples, to support transmitting the uplink trigger, the uplink trigger component 830 may be configured as or otherwise support a means for transmitting, via the AR, an indication of a UE group associated with the UE, a UE identifier associated with the UE, a cell group associated with the UE, a cell identifier of the cell group associated with the UE, or any combination thereof, where the uplink trigger includes the indication.

In some examples, the parameters associated with the ESRs, the CSRs, or both, include a first parameter associated with a duration of a monitoring window. In some examples, monitoring for the energy grants, the communication grants, or both, is based on the monitoring window.

In some examples, to support receiving the indication of the parameters associated with the uplink trigger configuration, the configuration component 825 may be configured as or otherwise support a means for receiving an indication of one or more waveforms associated with transmission of the uplink trigger, where the parameters include the indication of the one or more waveforms, and where transmitting the uplink trigger is based on the one or more waveforms.

In some examples, the one or more waveforms are associated with one or more uplink trigger sequences.

In some examples, a first set of uplink trigger sequences from the one or more uplink trigger sequences are associated with the ESRs and a second set of uplink trigger sequences from the one or more uplink trigger sequences are associated with the CSRs, and the sequence component 855 may be configured as or otherwise support a means for generating the first set of uplink trigger sequences and the second set of uplink trigger sequences based on a UE identifier, a cell identifier associated with the UE, or both.

In some examples, to support receiving the indication of the parameters associated with the uplink trigger configuration, the sequence component 855 may be configured as or otherwise support a means for receiving an indication of a scrambling sequence, where the scrambling sequence is based on an identifier associated with the network entity. In some examples, to support receiving the indication of the parameters associated with the uplink trigger configuration, the sequence component 855 may be configured as or otherwise support a means for generating the one or more uplink trigger sequences based on the scrambling sequence.

In some examples, the scrambling sequence is based on a system frame number, a slot index, a counter, or any combination thereof.

In some examples, each of the one or more uplink trigger sequences are preceded by a training sequence, followed by a training sequence, or both.

In some examples, each of the one or more uplink trigger sequences are associated with a preamble.

In some examples, the one or more waveforms are associated with one or more chirps. In some examples, a first set of chirps from the one or more chirps are associated with the ESRs and a second set of chirps from the one or more chirps are associated with the CSRs.

In some examples, to support receiving the indication of the parameters associated with the uplink trigger configuration, the uplink trigger component 830 may be configured as or otherwise support a means for receiving an indication of a format associated with the uplink trigger, where the format includes a header, an address, an indication of the ESRs, the CSRs, or both, a cyclic redundancy check, a training sequence, or any combination thereof. In some examples, to support receiving the indication of the parameters associated with the uplink trigger configuration, the uplink trigger component 830 may be configured as or otherwise support a means for transmitting, via the AR, the uplink trigger in accordance with the indicated format.

In some examples, the configuration component 825 may be configured as or otherwise support a means for receiving, from the network entity, control signaling indicating a duty cycle configuration associated with transmission of the uplink trigger, where transmitting the uplink trigger is based on the duty cycle configuration.

In some examples, the duty cycle configuration is based on a congestion level, a priority associated with the ESRs, a priority associated with the CSRs, an energy state of the UE, a power consumption associated with the transmission of the uplink trigger.

In some examples, the reporting component 845 may be configured as or otherwise support a means for transmitting, to the network entity, a report including an indication of one or more energy consumptions associated with the transmission of the uplink trigger at different transmit power levels, a recommended duty cycle configuration, or both, where the indicated duty cycle configuration is based on the report.

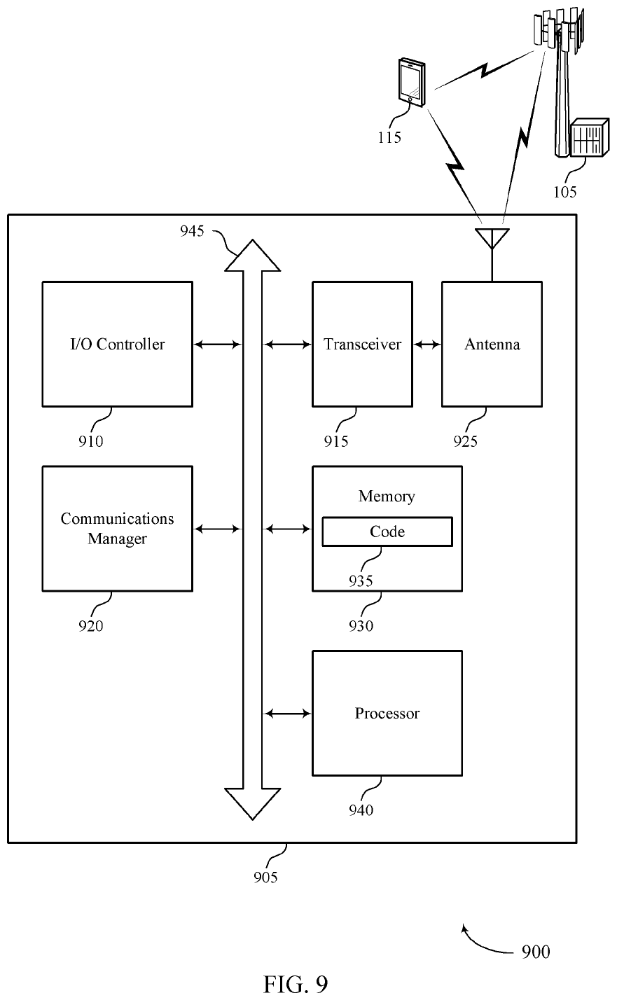

FIG. 9 shows a diagram of a system 900 including a device 905 that supports asynchronous uplink trigger design in accordance with one or more aspects of the present disclosure. The device 905 may be an example of or include the components of a device 605, a device 705, or a UE 115 as described herein. The device 905 may communicate (e.g., wirelessly) with one or more network entities 105, one or more UEs 115, or any combination thereof. The device 905 may include components for bi-directional voice and data communications including components for transmitting and receiving communications, such as a communications manager 920, an input/output (I/O) controller 910, a transceiver 915, an antenna 925, a memory 930, code 935, and a processor 940. These components may be in electronic communication or otherwise coupled (e.g., operatively, communicatively, functionally, electronically, electrically) via one or more buses (e.g., a bus 945).

The I/O controller 910 may manage input and output signals for the device 905. The I/O controller 910 may also manage peripherals not integrated into the device 905. In some cases, the I/O controller 910 may represent a physical connection or port to an external peripheral. In some cases, the I/O controller 910 may utilize an operating system such as iOS®, ANDROID®, MS-DOS®, MS-WINDOWS®, OS/2®, UNIX®, LINUX®, or another known operating system. Additionally, or alternatively, the I/O controller 910 may represent or interact with a modem, a keyboard, a mouse, a touchscreen, or a similar device. In some cases, the I/O controller 910 may be implemented as part of a processor, such as the processor 940. In some cases, a user may interact with the device 905 via the I/O controller 910 or via hardware components controlled by the I/O controller 910.

In some cases, the device 905 may include a single antenna 925. However, in some other cases, the device 905 may have more than one antenna 925, which may be capable of concurrently transmitting or receiving multiple wireless transmissions. The transceiver 915 may communicate bi-directionally, via the one or more antennas 925, wired, or wireless links as described herein. For example, the transceiver 915 may represent a wireless transceiver and may communicate bi-directionally with another wireless transceiver. The transceiver 915 may also include a modem to modulate the packets, to provide the modulated packets to one or more antennas 925 for transmission, and to demodulate packets received from the one or more antennas 925. The transceiver 915, or the transceiver 915 and one or more antennas 925, may be an example of a transmitter 615, a transmitter 715, a receiver 610, a receiver 710, or any combination thereof or component thereof, as described herein.

The memory 930 may include random access memory (RAM) and read-only memory (ROM). The memory 930 may store computer-readable, computer-executable code 935 including instructions that, when executed by the processor 940, cause the device 905 to perform various functions described herein. The code 935 may be stored in a non-transitory computer-readable medium such as system memory or another type of memory. In some cases, the code 935 may not be directly executable by the processor 940 but may cause a computer (e.g., when compiled and executed) to perform functions described herein. In some cases, the memory 930 may contain, among other things, a basic I/O system (BIOS) which may control basic hardware or software operation such as the interaction with peripheral components or devices.

The processor 940 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 940 may be configured to operate a memory array using a memory controller. In some other cases, a memory controller may be integrated into the processor 940. The processor 940 may be configured to execute computer-readable instructions stored in a memory (e.g., the memory 930) to cause the device 905 to perform various functions (e.g., functions or tasks supporting asynchronous uplink trigger design). For example, the device 905 or a component of the device 905 may include a processor 940 and memory 930 coupled with or to the processor 940, the processor 940 and memory 930 configured to perform various functions described herein.

The communications manager 920 may support wireless communications at a UE in accordance with examples as disclosed herein. For example, the communications manager 920 may be configured as or otherwise support a means for receiving, from a network entity, an indication of parameters associated with an uplink trigger configuration, where the parameters are associated with ESRs, CSRs, or both. The communications manager 920 may be configured as or otherwise support a means for transmitting, via an AR, an uplink trigger based on the uplink trigger configuration, where the uplink trigger includes the ESRs, the CSRs, or both. The communications manager 920 may be configured as or otherwise support a means for monitoring, via a BR, for energy grants, communication grants, or both, based on the uplink trigger, where the monitoring is based on the uplink trigger configuration.

By including or configuring the communications manager 920 in accordance with examples as described herein, the device 905 may support techniques for asynchronous uplink trigger design which may result in improved communication reliability, reduced latency, improved user experience related to reduced processing, reduced power consumption, more efficient utilization of communication resources, improved coordination between devices, longer battery life, and improved utilization of processing capability, among other advantages.

In some examples, the communications manager 920 may be configured to perform various operations (e.g., receiving, monitoring, transmitting) using or otherwise in cooperation with the transceiver 915, the one or more antennas 925, or any combination thereof. Although the communications manager 920 is illustrated as a separate component, in some examples, one or more functions described with reference to the communications manager 920 may be supported by or performed by the processor 940, the memory 930, the code 935, or any combination thereof. For example, the code 935 may include instructions executable by the processor 940 to cause the device 905 to perform various aspects of asynchronous uplink trigger design as described herein, or the processor 940 and the memory 930 may be otherwise configured to perform or support such operations.

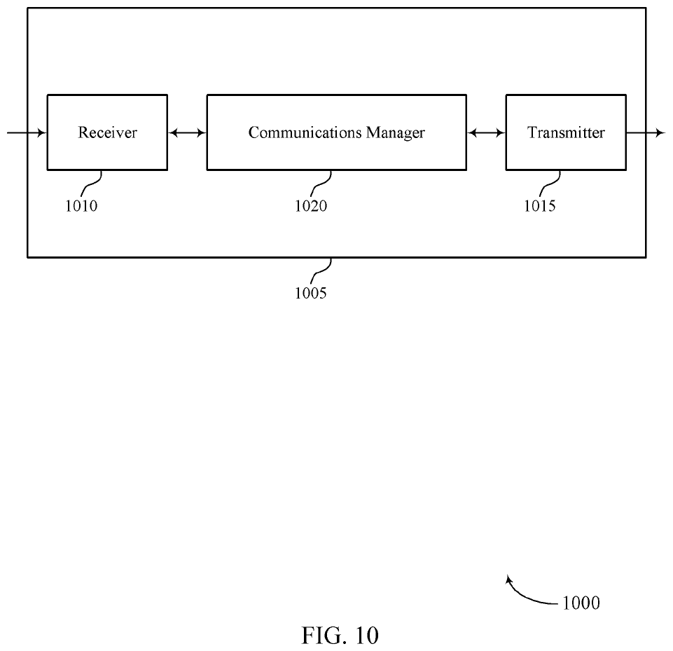

FIG. 10 shows a block diagram 1000 of a device 1005 that supports asynchronous uplink trigger design in accordance with one or more aspects of the present disclosure. The device 1005 may be an example of aspects of a network entity 105 as described herein. The device 1005 may include a receiver 1010, a transmitter 1015, and a communications manager 1020. The device 1005 may also include a processor. Each of these components may be in communication with one another (e.g., via one or more buses).

The receiver 1010 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1005. In some examples, the receiver 1010 may support obtaining information by receiving signals via one or more antennas. Additionally, or alternatively, the receiver 1010 may support obtaining information by receiving signals via one or more wired (e.g., electrical, fiber optic) interfaces, wireless interfaces, or any combination thereof.

The transmitter 1015 may provide a means for outputting (e.g., transmitting, providing, conveying, sending) information generated by other components of the device 1005. For example, the transmitter 1015 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1015 may support outputting information by transmitting signals via one or more antennas. Additionally, or alternatively, the transmitter 1015 may support outputting information by transmitting signals via one or more wired (e.g., electrical, fiber optic) interfaces, wireless interfaces, or any combination thereof. In some examples, the transmitter 1015 and the receiver 1010 may be co-located in a transceiver, which may include or be coupled with a modem.

The communications manager 1020, the receiver 1010, the transmitter 1015, or various combinations thereof or various components thereof may be examples of means for performing various aspects of asynchronous uplink trigger design as described herein. For example, the communications manager 1020, the receiver 1010, the transmitter 1015, or various combinations or components thereof may support a method for performing one or more of the functions described herein.

In some examples, the communications manager 1020, the receiver 1010, the transmitter 1015, or various combinations or components thereof may be implemented in hardware (e.g., in communications management circuitry). The hardware may include a processor, a DSP, a CPU, an ASIC, an FPGA or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 1020, the receiver 1010, the transmitter 1015, or various combinations or components thereof may be implemented in code (e.g., as communications management software or firmware) executed by a processor. If implemented in code executed by a processor, the functions of the communications manager 1020, the receiver 1010, the transmitter 1015, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 1020 may be configured to perform various operations (e.g., receiving, obtaining, monitoring, outputting, transmitting) using or otherwise in cooperation with the receiver 1010, the transmitter 1015, or both. For example, the communications manager 1020 may receive information from the receiver 1010, send information to the transmitter 1015, or be integrated in combination with the receiver 1010, the transmitter 1015, or both to obtain information, output information, or perform various other operations as described herein.

The communications manager 1020 may support wireless communications at a network entity in accordance with examples as disclosed herein. For example, the communications manager 1020 may be configured as or otherwise support a means for outputting an indication of parameters associated with an uplink trigger configuration, where the parameters are associated with ESRs, CSRs, or both. The communications manager 1020 may be configured as or otherwise support a means for obtaining an uplink trigger based on the uplink trigger configuration, where the uplink trigger includes the ESRs, the CSRs, or both. The communications manager 1020 may be configured as or otherwise support a means for outputting energy grants, communication grants, or both, based on the uplink trigger, where the outputting is based on the uplink trigger configuration.

By including or configuring the communications manager 1020 in accordance with examples as described herein, the device 1005 (e.g., a processor controlling or otherwise coupled with the receiver 1010, the transmitter 1015, the communications manager 1020, or a combination thereof) may support techniques for asynchronous uplink trigger design which may result in reduced processing, reduced power consumption, and more efficient utilization of communication resources, among other advantages.

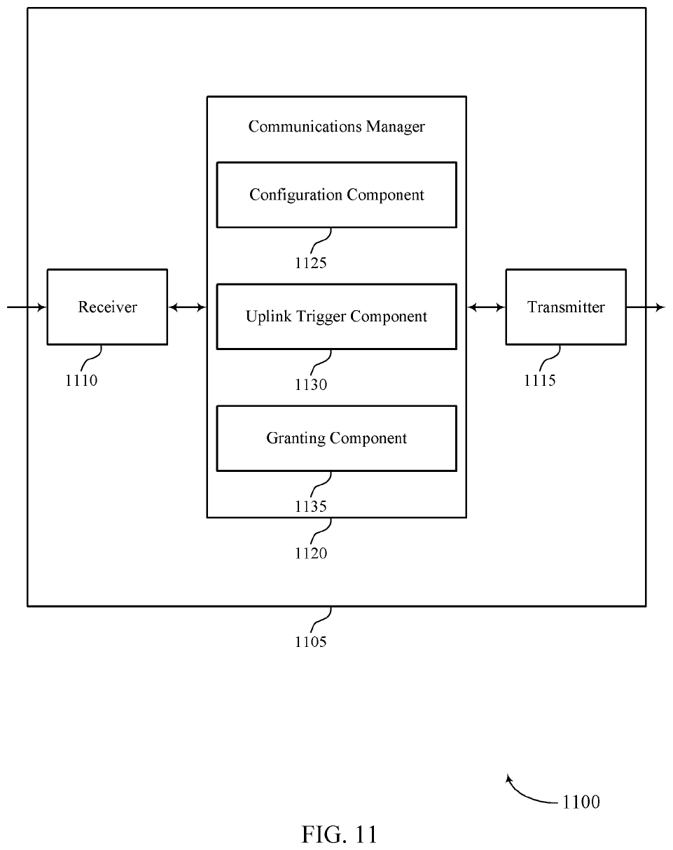

FIG. 11 shows a block diagram 1100 of a device 1105 that supports asynchronous uplink trigger design in accordance with one or more aspects of the present disclosure. The device 1105 may be an example of aspects of a device 1005 or a network entity 105 as described herein. The device 1105 may include a receiver 1110, a transmitter 1115, and a communications manager 1120. The device 1105 may also include a processor. Each of these components may be in communication with one another (e.g., via one or more buses).

The receiver 1110 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1105. In some examples, the receiver 1110 may support obtaining information by receiving signals via one or more antennas. Additionally, or alternatively, the receiver 1110 may support obtaining information by receiving signals via one or more wired (e.g., electrical, fiber optic) interfaces, wireless interfaces, or any combination thereof.

The transmitter 1115 may provide a means for outputting (e.g., transmitting, providing, conveying, sending) information generated by other components of the device 1105. For example, the transmitter 1115 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1115 may support outputting information by transmitting signals via one or more antennas. Additionally, or alternatively, the transmitter 1115 may support outputting information by transmitting signals via one or more wired (e.g., electrical, fiber optic) interfaces, wireless interfaces, or any combination thereof. In some examples, the transmitter 1115 and the receiver 1110 may be co-located in a transceiver, which may include or be coupled with a modem.

The device 1105, or various components thereof, may be an example of means for performing various aspects of asynchronous uplink trigger design as described herein. For example, the communications manager 1120 may include a configuration component 1125, an uplink trigger component 1130, a granting component 1135, or any combination thereof. The communications manager 1120 may be an example of aspects of a communications manager 1020 as described herein. In some examples, the communications manager 1120, or various components thereof, may be configured to perform various operations (e.g., receiving, obtaining, monitoring, outputting, transmitting) using or otherwise in cooperation with the receiver 1110, the transmitter 1115, or both. For example, the communications manager 1120 may receive information from the receiver 1110, send information to the transmitter 1115, or be integrated in combination with the receiver 1110, the transmitter 1115, or both to obtain information, output information, or perform various other operations as described herein.

The communications manager 1120 may support wireless communications at a network entity in accordance with examples as disclosed herein. The configuration component 1125 may be configured as or otherwise support a means for outputting an indication of parameters associated with an uplink trigger configuration, where the parameters are associated with ESRs, CSRs, or both. The uplink trigger component 1130 may be configured as or otherwise support a means for obtaining an uplink trigger based on the uplink trigger configuration, where the uplink trigger includes the ESRs, the CSRs, or both. The granting component 1135 may be configured as or otherwise support a means for outputting energy grants, communication grants, or both, based on the uplink trigger, where the outputting is based on the uplink trigger configuration.

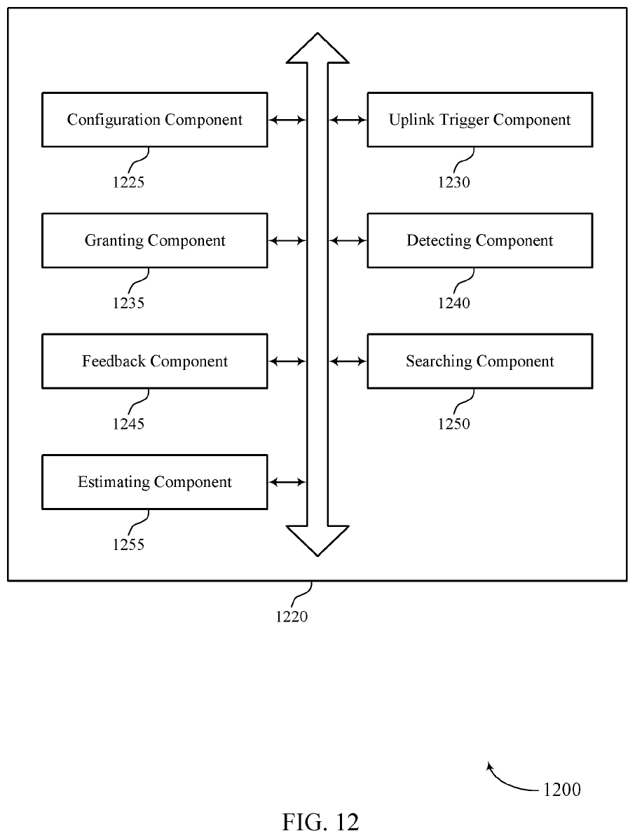

FIG. 12 shows a block diagram 1200 of a communications manager 1220 that supports asynchronous uplink trigger design in accordance with one or more aspects of the present disclosure. The communications manager 1220 may be an example of aspects of a communications manager 1020, a communications manager 1120, or both, as described herein. The communications manager 1220, or various components thereof, may be an example of means for performing various aspects of asynchronous uplink trigger design as described herein. For example, the communications manager 1220 may include a configuration component 1225, an uplink trigger component 1230, a granting component 1235, a detecting component 1240, a feedback component 1245, a searching component 1250, an estimating component 1255, or any combination thereof. Each of these components may communicate, directly or indirectly, with one another (e.g., via one or more buses) which may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 1220 may support wireless communications at a network entity in accordance with examples as disclosed herein. The configuration component 1225 may be configured as or otherwise support a means for outputting an indication of parameters associated with an uplink trigger configuration, where the parameters are associated with ESRs, CSRs, or both. The uplink trigger component 1230 may be configured as or otherwise support a means for obtaining an uplink trigger based on the uplink trigger configuration, where the uplink trigger includes the ESRs, the CSRs, or both. The granting component 1235 may be configured as or otherwise support a means for outputting energy grants, communication grants, or both, based on the uplink trigger, where the outputting is based on the uplink trigger configuration.

In some examples, the detecting component 1240 may be configured as or otherwise support a means for detecting one or more uplink trigger sequences associated with the uplink trigger from a set of uplink trigger sequences based on an identifier associated with a UE, where outputting the energy grants, the communication grants, or both, is based on detecting the one or more uplink trigger sequences.

In some examples, to support detecting the one or more uplink trigger sequence, the detecting component 1240 may be configured as or otherwise support a means for detecting a preamble associated with the uplink trigger. In some examples, to support detecting the one or more uplink trigger sequence, the searching component 1250 may be configured as or otherwise support a means for searching the set of uplink trigger sequences based on detecting the preamble, where detecting the one or more uplink trigger sequences from the set of uplink trigger sequences is based on the searching.

In some examples, the estimating component 1255 may be configured as or otherwise support a means for estimating a frequency offset associated with the uplink trigger and a channel associated with the uplink trigger, where detecting the one or more uplink trigger sequences is based on the frequency offset and channel.

In some examples, the feedback component 1245 may be configured as or otherwise support a means for obtaining an acknowledgment message indicating reception of the parameters associated with the uplink trigger configuration by a UE.

In some examples, the configuration component 1225 may be configured as or otherwise support a means for outputting an indication of a first quantity of repetitions of the uplink trigger, a second quantity of repetitions of the uplink trigger, a third quantity of repetitions of the uplink trigger, a set of thresholds, or any combination thereof, where a first coverage level of a UE is associated with the first quantity of repetitions, a second coverage level of the UE is associated with the second quantity of repetitions, and a third coverage level of the UE is associated with the third quantity of repetitions, and where the set of thresholds is associated with the first coverage level, the second coverage level, the third coverage level, or any combination thereof.

In some examples, to support obtaining the uplink trigger, the uplink trigger component 1230 may be configured as or otherwise support a means for obtaining an indication of a UE group associated with a UE, a UE identifier associated with the UE, a cell group associated with the UE, a cell identifier of the cell group associated with the UE, or any combination thereof, where the uplink trigger includes the indication.

In some examples, the parameters associated with the ESRs, the CSRs, or both, include a first parameter associated with a duration of a monitoring window.

In some examples, to support outputting the indication of the parameters associated with the uplink trigger configuration, the configuration component 1225 may be configured as or otherwise support a means for outputting an indication of one or more waveforms associated with transmission of the uplink trigger by a UE, where the parameters include the indication of the one or more waveforms, and where obtaining the uplink trigger is based on the one or more waveforms.

In some examples, the one or more waveforms are associated with one or more uplink trigger sequences.

In some examples, a first set of uplink trigger sequences from the one or more uplink trigger sequences are associated with the ESRs and a second set of uplink trigger sequences from the one or more uplink trigger sequences are associated with the CSRs.

In some examples, to support outputting the indication of the parameters associated with the uplink trigger configuration, the configuration component 1225 may be configured as or otherwise support a means for outputting an indication of a scrambling sequence, where the scrambling sequence is based on an identifier associated with the network entity.

In some examples, the scrambling sequence is based on a system frame number, a slot index, a counter, or any combination thereof.

In some examples, each of the one or more uplink trigger sequences are preceded by a training sequence, followed by a training sequence, or both.

In some examples, each of the one or more uplink trigger sequences are associated with a preamble.

In some examples, the one or more waveforms are associated with one or more chirps. In some examples, a first set of chirps from the one or more chirps are associated with the ESRs and a second set of chirps from the one or more chirps are associated with the CSRs.

In some examples, to support outputting the indication of the parameters associated with the uplink trigger configuration, the configuration component 1225 may be configured as or otherwise support a means for outputting an indication of a format associated the uplink trigger, where the format includes a header, an address, an indication of the ESRs, the CSRs, or both, a cyclic redundancy check, a training sequence, or any combination thereof. In some examples, to support outputting the indication of the parameters associated with the uplink trigger configuration, the uplink trigger component 1230 may be configured as or otherwise support a means for obtaining the uplink trigger in accordance with the indicated format.

In some examples, the configuration component 1225 may be configured as or otherwise support a means for outputting control signaling indicating a duty cycle configuration associated with transmission of the uplink trigger, where obtaining the uplink trigger is based on the duty cycle configuration.

In some examples, the duty cycle configuration is based on a congestion level, a priority associated with the ESRs, a priority associated with the CSRs, an energy state of a UE, a power consumption associated with the transmission of the uplink trigger.

In some examples, the feedback component 1245 may be configured as or otherwise support a means for receiving a report including an indication of one or more energy consumptions associated with transmission of the uplink trigger at different transmit power levels, a recommended duty cycle configuration, or both, where the indicated duty cycle configuration is based on the report.

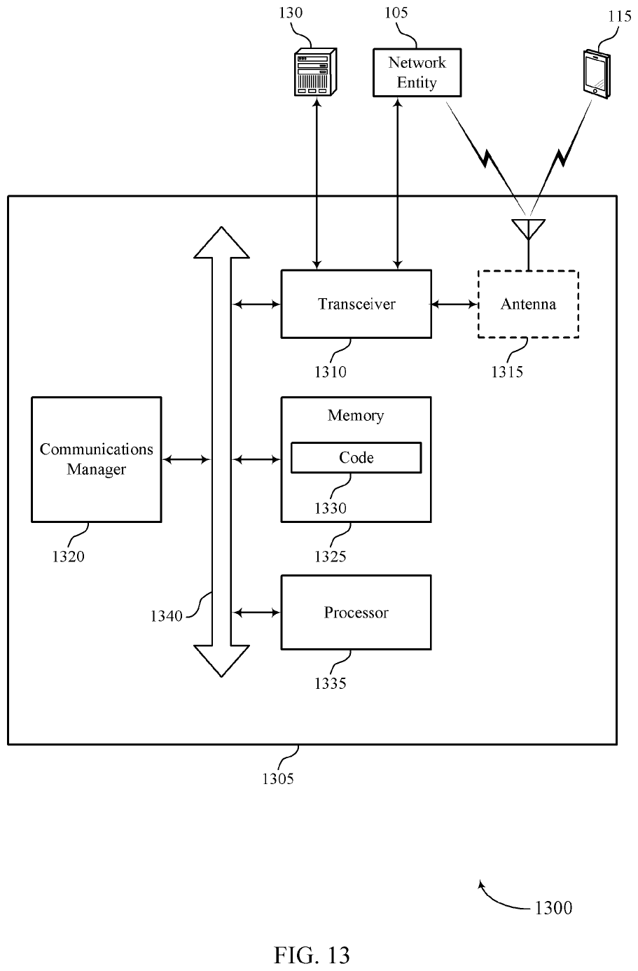

FIG. 13 shows a diagram of a system 1300 including a device 1305 that supports asynchronous uplink trigger design in accordance with one or more aspects of the present disclosure. The device 1305 may be an example of or include the components of a device 1005, a device 1105, or a network entity 105 as described herein. The device 1305 may communicate with one or more network entities 105, one or more UEs 115, or any combination thereof, which may include communications over one or more wired interfaces, over one or more wireless interfaces, or any combination thereof. The device 1305 may include components that support outputting and obtaining communications, such as a communications manager 1320, a transceiver 1310, an antenna 1315, a memory 1325, code 1330, and a processor 1335. These components may be in electronic communication or otherwise coupled (e.g., operatively, communicatively, functionally, electronically, electrically) via one or more buses (e.g., a bus 1340).

The transceiver 1310 may support bi-directional communications via wired links, wireless links, or both as described herein. In some examples, the transceiver 1310 may include a wired transceiver and may communicate bi-directionally with another wired transceiver. Additionally, or alternatively, in some examples, the transceiver 1310 may include a wireless transceiver and may communicate bi-directionally with another wireless transceiver. In some examples, the device 1305 may include one or more antennas 1315, which may be capable of transmitting or receiving wireless transmissions (e.g., concurrently). The transceiver 1310 may also include a modem to modulate signals, to provide the modulated signals for transmission (e.g., by one or more antennas 1315, by a wired transmitter), to receive modulated signals (e.g., from one or more antennas 1315, from a wired receiver), and to demodulate signals. In some implementations, the transceiver 1310 may include one or more interfaces, such as one or more interfaces coupled with the one or more antennas 1315 that are configured to support various receiving or obtaining operations, or one or more interfaces coupled with the one or more antennas 1315 that are configured to support various transmitting or outputting operations, or a combination thereof. In some implementations, the transceiver 1310 may include or be configured for coupling with one or more processors or memory components that are operable to perform or support operations based on received or obtained information or signals, or to generate information or other signals for transmission or other outputting, or any combination thereof. In some implementations, the transceiver 1310, or the transceiver 1310 and the one or more antennas 1315, or the transceiver 1310 and the one or more antennas 1315 and one or more processors or memory components (for example, the processor 1335, or the memory 1325, or both), may be included in a chip or chip assembly that is installed in the device 1305. In some examples, the transceiver may be operable to support communications via one or more communications links (e.g., a communication link 125, a backhaul communication link 120, a midhaul communication link 162, a fronthaul communication link 168).

The memory 1325 may include RAM and ROM. The memory 1325 may store computer-readable, computer-executable code 1330 including instructions that, when executed by the processor 1335, cause the device 1305 to perform various functions described herein. The code 1330 may be stored in a non-transitory computer-readable medium such as system memory or another type of memory. In some cases, the code 1330 may not be directly executable by the processor 1335 but may cause a computer (e.g., when compiled and executed) to perform functions described herein. In some cases, the memory 1325 may contain, among other things, a BIOS which may control basic hardware or software operation such as the interaction with peripheral components or devices.

The processor 1335 may include an intelligent hardware device (e.g., a general-purpose processor, a DSP, an ASIC, a CPU, an FPGA, a microcontroller, a programmable logic device, discrete gate or transistor logic, a discrete hardware component, or any combination thereof). In some cases, the processor 1335 may be configured to operate a memory array using a memory controller. In some other cases, a memory controller may be integrated into the processor 1335. The processor 1335 may be configured to execute computer-readable instructions stored in a memory (e.g., the memory 1325) to cause the device 1305 to perform various functions (e.g., functions or tasks supporting asynchronous uplink trigger design). For example, the device 1305 or a component of the device 1305 may include a processor 1335 and memory 1325 coupled with the processor 1335, the processor 1335 and memory 1325 configured to perform various functions described herein. The processor 1335 may be an example of a cloud-computing platform (e.g., one or more physical nodes and supporting software such as operating systems, virtual machines, or container instances) that may host the functions (e.g., by executing code 1330) to perform the functions of the device 1305. The processor 1335 may be any one or more suitable processors capable of executing scripts or instructions of one or more software programs stored in the device 1305 (such as within the memory 1325). In some implementations, the processor 1335 may be a component of a processing system. A processing system may generally refer to a system or series of machines or components that receives inputs and processes the inputs to produce a set of outputs (which may be passed to other systems or components of, for example, the device 1305). For example, a processing system of the device 1305 may refer to a system including the various other components or subcomponents of the device 1305, such as the processor 1335, or the transceiver 1310, or the communications manager 1320, or other components or combinations of components of the device 1305. The processing system of the device 1305 may interface with other components of the device 1305, and may process information received from other components (such as inputs or signals) or output information to other components. For example, a chip or modem of the device 1305 may include a processing system and one or more interfaces to output information, or to obtain information, or both. The one or more interfaces may be implemented as or otherwise include a first interface configured to output information and a second interface configured to obtain information, or a same interface configured to output information and to obtain information, among other implementations. In some implementations, the one or more interfaces may refer to an interface between the processing system of the chip or modem and a transmitter, such that the device 1305 may transmit information output from the chip or modem. Additionally, or alternatively, in some implementations, the one or more interfaces may refer to an interface between the processing system of the chip or modem and a receiver, such that the device 1305 may obtain information or signal inputs, and the information may be passed to the processing system. A person having ordinary skill in the art will readily recognize that a first interface also may obtain information or signal inputs, and a second interface also may output information or signal outputs.

In some examples, a bus 1340 may support communications of (e.g., within) a protocol layer of a protocol stack. In some examples, a bus 1340 may support communications associated with a logical channel of a protocol stack (e.g., between protocol layers of a protocol stack), which may include communications performed within a component of the device 1305, or between different components of the device 1305 that may be co-located or located in different locations (e.g., where the device 1305 may refer to a system in which one or more of the communications manager 1320, the transceiver 1310, the memory 1325, the code 1330, and the processor 1335 may be located in one of the different components or divided between different components).

In some examples, the communications manager 1320 may manage aspects of communications with a core network 130 (e.g., via one or more wired or wireless backhaul links). For example, the communications manager 1320 may manage the transfer of data communications for client devices, such as one or more UEs 115. In some examples, the communications manager 1320 may manage communications with other network entities 105, and may include a controller or scheduler for controlling communications with UEs 115 in cooperation with other network entities 105. In some examples, the communications manager 1320 may support an X2 interface within an LTE/LTE-A wireless communications network technology to provide communication between network entities 105.

The communications manager 1320 may support wireless communications at a network entity in accordance with examples as disclosed herein. For example, the communications manager 1320 may be configured as or otherwise support a means for outputting an indication of parameters associated with an uplink trigger configuration, where the parameters are associated with ESRs, CSRs, or both. The communications manager 1320 may be configured as or otherwise support a means for obtaining an uplink trigger based on the uplink trigger configuration, where the uplink trigger includes the ESRs, the CSRs, or both. The communications manager 1320 may be configured as or otherwise support a means for outputting energy grants, communication grants, or both, based on the uplink trigger, where the outputting is based on the uplink trigger configuration.

By including or configuring the communications manager 1320 in accordance with examples as described herein, the device 1305 may support techniques for asynchronous uplink trigger design which may result in improved communication reliability, reduced latency, improved user experience related to reduced processing, reduced power consumption, more efficient utilization of communication resources, improved coordination between devices, longer battery life, and improved utilization of processing capability, among other advantages.

In some examples, the communications manager 1320 may be configured to perform various operations (e.g., receiving, obtaining, monitoring, outputting, transmitting) using or otherwise in cooperation with the transceiver 1310, the one or more antennas 1315 (e.g., where applicable), or any combination thereof. Although the communications manager 1320 is illustrated as a separate component, in some examples, one or more functions described with reference to the communications manager 1320 may be supported by or performed by the transceiver 1310, the processor 1335, the memory 1325, the code 1330, or any combination thereof. For example, the code 1330 may include instructions executable by the processor 1335 to cause the device 1305 to perform various aspects of asynchronous uplink trigger design as described herein, or the processor 1335 and the memory 1325 may be otherwise configured to perform or support such operations.

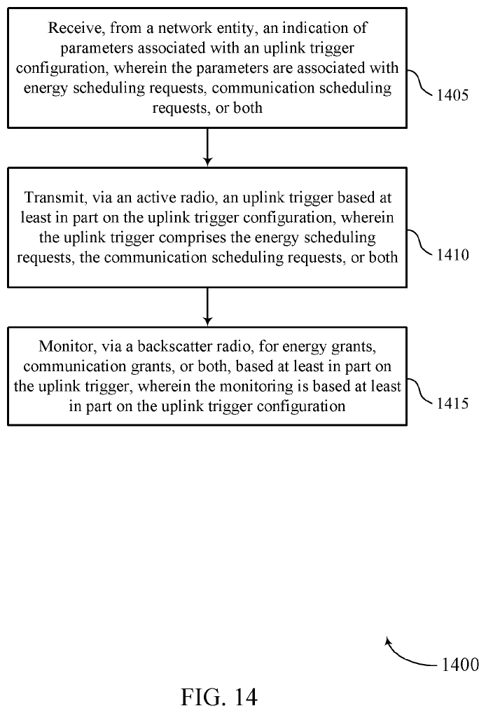

FIG. 14 shows a flowchart illustrating a method 1400 that supports asynchronous uplink trigger design in accordance with one or more aspects of the present disclosure. The operations of the method 1400 may be implemented by a UE or its components as described herein. For example, the operations of the method 1400 may be performed by a UE 115 as described with reference to FIGS. 1 through 9. In some examples, a UE may execute a set of instructions to control the functional elements of the UE to perform the described functions. Additionally, or alternatively, the UE may perform aspects of the described functions using special-purpose hardware.

At 1405, the method may include receiving, from a network entity, an indication of parameters associated with an uplink trigger configuration, where the parameters are associated with ESRs, CSRs, or both. The operations of 1405 may be performed in accordance with examples as disclosed herein. In some examples, aspects of the operations of 1405 may be performed by a configuration component 825 as described with reference to FIG. 8.

At 1410, the method may include transmitting, via an AR, an uplink trigger based on the uplink trigger configuration, where the uplink trigger includes the ESRs, the CSRs, or both. The operations of 1410 may be performed in accordance with examples as disclosed herein. In some examples, aspects of the operations of 1410 may be performed by an uplink trigger component 830 as described with reference to FIG. 8.

At 1415, the method may include monitoring, via a BR, for energy grants, communication grants, or both, based on the uplink trigger, where the monitoring is based on the uplink trigger configuration. The operations of 1415 may be performed in accordance with examples as disclosed herein. In some examples, aspects of the operations of 1415 may be performed by a monitoring component 835 as described with reference to FIG. 8.

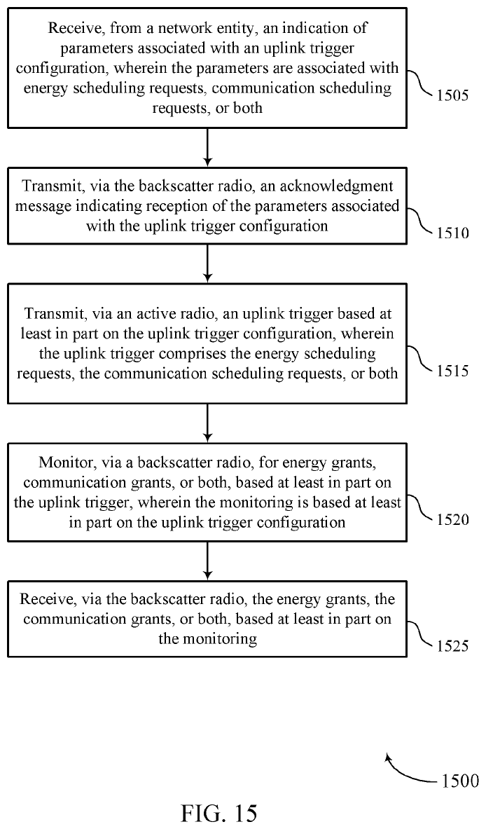

FIG. 15 shows a flowchart illustrating a method 1500 that supports asynchronous uplink trigger design in accordance with one or more aspects of the present disclosure. The operations of the method 1500 may be implemented by a UE or its components as described herein. For example, the operations of the method 1500 may be performed by a UE 115 as described with reference to FIGS. 1 through 9. In some examples, a UE may execute a set of instructions to control the functional elements of the UE to perform the described functions. Additionally, or alternatively, the UE may perform aspects of the described functions using special-purpose hardware.

At 1505, the method may include receiving, from a network entity, an indication of parameters associated with an uplink trigger configuration, where the parameters are associated with ESRs, CSRs, or both. The operations of 1505 may be performed in accordance with examples as disclosed herein. In some examples, aspects of the operations of 1505 may be performed by a configuration component 825 as described with reference to FIG. 8.

At 1510, the method may include transmitting, via the BR, an acknowledgment message indicating reception of the parameters associated with the uplink trigger configuration. The operations of 1510 may be performed in accordance with examples as disclosed herein. In some examples, aspects of the operations of 1510 may be performed by a feedback component 840 as described with reference to FIG. 8.

At 1515, the method may include transmitting, via an AR, an uplink trigger based on the uplink trigger configuration, where the uplink trigger includes the ESRs, the CSRs, or both. The operations of 1515 may be performed in accordance with examples as disclosed herein. In some examples, aspects of the operations of 1515 may be performed by an uplink trigger component 830 as described with reference to FIG. 8.

At 1520, the method may include monitoring, via a BR, for energy grants, communication grants, or both, based on the uplink trigger, where the monitoring is based on the uplink trigger configuration. The operations of 1520 may be performed in accordance with examples as disclosed herein. In some examples, aspects of the operations of 1520 may be performed by a monitoring component 835 as described with reference to FIG. 8.

At 1525, the method may include receiving, via the BR, the energy grants, the communication grants, or both, based on the monitoring. The operations of 1525 may be performed in accordance with examples as disclosed herein. In some examples, aspects of the operations of 1525 may be performed by a monitoring component 835 as described with reference to FIG. 8.

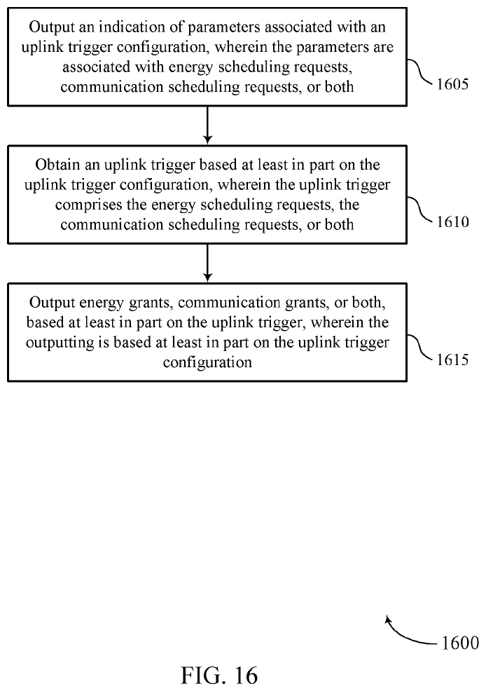

FIG. 16 shows a flowchart illustrating a method 1600 that supports asynchronous uplink trigger design in accordance with one or more aspects of the present disclosure. The operations of the method 1600 may be implemented by a network entity or its components as described herein. For example, the operations of the method 1600 may be performed by a network entity as described with reference to FIGS. 1 through 5 and 10 through 13. In some examples, a network entity may execute a set of instructions to control the functional elements of the network entity to perform the described functions. Additionally, or alternatively, the network entity may perform aspects of the described functions using special-purpose hardware.

At 1605, the method may include outputting an indication of parameters associated with an uplink trigger configuration, where the parameters are associated with ESRs, CSRs, or both. The operations of 1605 may be performed in accordance with examples as disclosed herein. In some examples, aspects of the operations of 1605 may be performed by a configuration component 1225 as described with reference to FIG. 12.

At 1610, the method may include obtaining an uplink trigger based on the uplink trigger configuration, where the uplink trigger includes the ESRs, the CSRs, or both. The operations of 1610 may be performed in accordance with examples as disclosed herein. In some examples, aspects of the operations of 1610 may be performed by an uplink trigger component 1230 as described with reference to FIG. 12.

At 1615, the method may include outputting energy grants, communication grants, or both, based on the uplink trigger, where the outputting is based on the uplink trigger configuration. The operations of 1615 may be performed in accordance with examples as disclosed herein. In some examples, aspects of the operations of 1615 may be performed by a granting component 1235 as described with reference to FIG. 12.

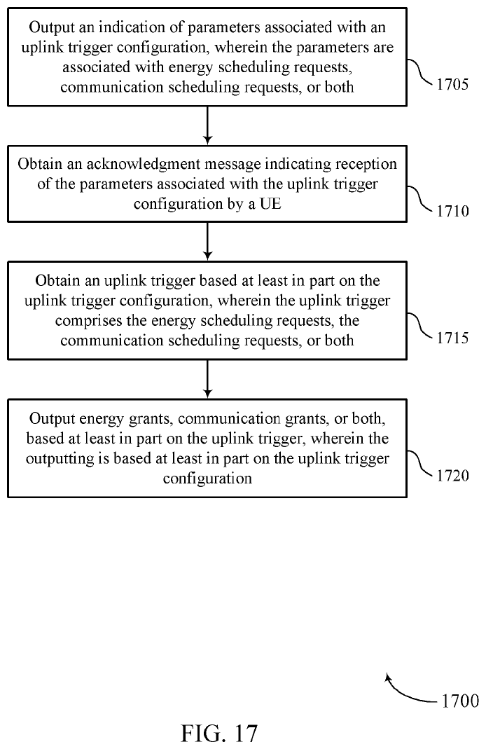

FIG. 17 shows a flowchart illustrating a method 1700 that supports asynchronous uplink trigger design in accordance with one or more aspects of the present disclosure. The operations of the method 1700 may be implemented by a network entity or its components as described herein. For example, the operations of the method 1700 may be performed by a network entity as described with reference to FIGS. 1 through 5 and 10 through 13. In some examples, a network entity may execute a set of instructions to control the functional elements of the network entity to perform the described functions. Additionally, or alternatively, the network entity may perform aspects of the described functions using special-purpose hardware.

At 1705, the method may include outputting an indication of parameters associated with an uplink trigger configuration, where the parameters are associated with ESRs, CSRs, or both. The operations of 1705 may be performed in accordance with examples as disclosed herein. In some examples, aspects of the operations of 1705 may be performed by a configuration component 1225 as described with reference to FIG. 12.

At 1710, the method may include obtaining an acknowledgment message indicating reception of the parameters associated with the uplink trigger configuration by a UE. The operations of 1710 may be performed in accordance with examples as disclosed herein. In some examples, aspects of the operations of 1710 may be performed by a feedback component 1245 as described with reference to FIG. 12.

At 1715, the method may include obtaining an uplink trigger based on the uplink trigger configuration, where the uplink trigger includes the ESRs, the CSRs, or both. The operations of 1715 may be performed in accordance with examples as disclosed herein. In some examples, aspects of the operations of 1715 may be performed by an uplink trigger component 1230 as described with reference to FIG. 12.

At 1720, the method may include outputting energy grants, communication grants, or both, based on the uplink trigger, where the outputting is based on the uplink trigger configuration. The operations of 1720 may be performed in accordance with examples as disclosed herein. In some examples, aspects of the operations of 1720 may be performed by a granting component 1235 as described with reference to FIG. 12.

The following provides an overview of aspects of the present disclosure:

Aspect 1: A method for wireless communications at a UE, comprising: receiving, from a network entity, an indication of parameters associated with an uplink trigger configuration, wherein the parameters are associated with ESRs, CSRs, or both; transmitting, via an AR, an uplink trigger based at least in part on the uplink trigger configuration, wherein the uplink trigger comprises the ESRs, the CSRs, or both; and monitoring, via a BR, for energy grants, communication grants, or both, based at least in part on the uplink trigger, wherein the monitoring is based at least in part on the uplink trigger configuration.

Aspect 2: The method of aspect 1, further comprising: receiving, via the BR, the energy grants, the communication grants, or both, based at least in part on the monitoring.

Aspect 3: The method of any of aspects 1 through 2, further comprising: transmitting, via the AR, a retransmission of the uplink trigger, based at least in part on failing to receive, via the BR, the energy grants, the communication grants, or both.

Aspect 4: The method of any of aspects 1 through 3, further comprising: transmitting, via the BR, an acknowledgment message indicating reception of the parameters associated with the uplink trigger configuration.

Aspect 5: The method of any of aspects 1 through 4, further comprising: transmitting a quantity of repetitions of the uplink trigger, wherein the quantity of repetitions is based at least in part on a coverage level of the UE, one or more signal measurements, a priority associated with the uplink trigger, the monitoring, or any combination thereof.

Aspect 6: The method of aspect 5, wherein a first coverage level of the UE is associated with a first quantity of repetitions, a second coverage level of the UE is associated with a second quantity of repetitions, and a third coverage level of the UE is associated with a third quantity of repetitions, wherein transmitting a quantity of repetitions of the uplink trigger comprises: transmitting the first quantity of repetitions, the second quantity of repetitions, or the third quantity of repetitions based at least in part on a set of thresholds associated with the first coverage level, the second coverage level, the third coverage level, or any combination thereof.

Aspect 7: The method of aspect 6, further comprising: receiving, from the network entity, an indication of the first quantity of repetitions, the second quantity of repetitions, the third quantity of repetitions, the set of thresholds, or any combination thereof.

Aspect 8: The method of any of aspects 6 through 7, further comprising: measuring a reference signal receive power of one or more reference signal transmissions received via the BR; and determining the coverage level of the UE based at least in part on the reference signal receive power of the one or more reference signal transmissions.

Aspect 9: The method of any of aspects 1 through 8, wherein transmitting the uplink trigger comprises: transmitting, via the AR, an indication of a UE group associated with the UE, a UE identifier associated with the UE, a cell group associated with the UE, a cell identifier of the cell group associated with the UE, or any combination thereof, wherein the uplink trigger comprises the indication.

Aspect 10: The method of any of aspects 1 through 9, wherein the parameters associated with the ESRs, the CSRs, or both, comprise a first parameter associated with a duration of a monitoring window, and monitoring for the energy grants, the communication grants, or both, is based at least in part on the monitoring window.

Aspect 11: The method of any of aspects 1 through 10, wherein receiving the indication of the parameters associated with the uplink trigger configuration comprises: receiving an indication of one or more waveforms associated with transmission of the uplink trigger, wherein the parameters comprise the indication of the one or more waveforms, and wherein transmitting the uplink trigger is based at least in part on the one or more waveforms.

Aspect 12: The method of aspect 11, wherein the one or more waveforms are associated with one or more uplink trigger sequences.

Aspect 13: The method of aspect 12, wherein a first set of uplink trigger sequences from the one or more uplink trigger sequences are associated with the ESRs and a second set of uplink trigger sequences from the one or more uplink trigger sequences are associated with the CSRs, the method further comprising: generating the first set of uplink trigger sequences and the second set of uplink trigger sequences based at least in part on a UE identifier, a cell identifier associated with the UE, or both.

Aspect 14: The method of any of aspects 12 through 13, wherein receiving the indication of the parameters associated with the uplink trigger configuration comprises: receiving an indication of a scrambling sequence, wherein the scrambling sequence is based at least in part on an identifier associated with the network entity; and generating the one or more uplink trigger sequences based at least in part on the scrambling sequence.

Aspect 15: The method of aspect 14, wherein the scrambling sequence is based at least in part on a SFN, a slot index, a counter, or any combination thereof.

Aspect 16: The method of any of aspects 12 through 15, wherein each of the one or more uplink trigger sequences are preceded by a training sequence, followed by a training sequence, or both.

Aspect 17: The method of any of aspects 12 through 16, wherein each of the one or more uplink trigger sequences are associated with a preamble.

Aspect 18: The method of aspect 11, wherein the one or more waveforms are associated with one or more chirps, and a first set of chirps from the one or more chirps are associated with the ESRs and a second set of chirps from the one or more chirps are associated with the CSRs.

Aspect 19: The method of any of aspects 1 through 11, wherein receiving the indication of the parameters associated with the uplink trigger configuration comprises: receiving an indication of a format associated with the uplink trigger, wherein the format comprises a header, an address, an indication of the ESRs, the CSRs, or both, a CRC, a training sequence, or any combination thereof; and transmitting, via the AR, the uplink trigger in accordance with the indicated format.

Aspect 20: The method of any of aspects 1 through 19, further comprising: receiving, from the network entity, control signaling indicating a duty cycle configuration associated with transmission of the uplink trigger, wherein transmitting the uplink trigger is based at least in part on the duty cycle configuration.

Aspect 21: The method of aspect 20, wherein the duty cycle configuration is based at least in part on a congestion level, a priority associated with the ESRs, a priority associated with the CSRs, an energy state of the UE, a power consumption associated with the transmission of the uplink trigger.

Aspect 22: The method of any of aspects 20 through 21, further comprising: transmitting, to the network entity, a report comprising an indication of one or more energy consumptions associated with the transmission of the uplink trigger at different transmit power levels, a recommended duty cycle configuration, or both, wherein the indicated duty cycle configuration is based at least in part on the report.

Aspect 23: A method for wireless communications at a network entity, comprising: outputting an indication of parameters associated with an uplink trigger configuration, wherein the parameters are associated with ESRs, CSRs, or both; obtaining an uplink trigger based at least in part on the uplink trigger configuration, wherein the uplink trigger comprises the ESRs, the CSRs, or both; and outputting energy grants, communication grants, or both, based at least in part on the uplink trigger, wherein the outputting is based at least in part on the uplink trigger configuration.

Aspect 24: The method of aspect 23, further comprising: detecting one or more uplink trigger sequences associated with the uplink trigger from a set of uplink trigger sequences based at least in part on an identifier associated with a UE, wherein outputting the energy grants, the communication grants, or both, is based at least in part on detecting the one or more uplink trigger sequences.

Aspect 25: The method of aspect 24, wherein detecting the one or more uplink trigger sequence comprises: detecting a preamble associated with the uplink trigger; and searching the set of uplink trigger sequences based at least in part on detecting the preamble, wherein detecting the one or more uplink trigger sequences from the set of uplink trigger sequences is based at least in part on the searching.

Aspect 26: The method of any of aspects 24 through 25, further comprising: estimating a frequency offset associated with the uplink trigger and a channel associated with the uplink trigger, wherein detecting the one or more uplink trigger sequences is based at least in part on the frequency offset and channel.

Aspect 27: The method of any of aspects 23 through 26, further comprising: obtaining an acknowledgment message indicating reception of the parameters associated with the uplink trigger configuration by a UE.

Aspect 28: The method of any of aspects 23 through 27, further comprising: outputting an indication of a first quantity of repetitions of the uplink trigger, a second quantity of repetitions of the uplink trigger, a third quantity of repetitions of the uplink trigger, a set of thresholds, or any combination thereof, wherein a first coverage level of a UE is associated with the first quantity of repetitions, a second coverage level of the UE is associated with the second quantity of repetitions, and a third coverage level of the UE is associated with the third quantity of repetitions, and wherein the set of thresholds is associated with the first coverage level, the second coverage level, the third coverage level, or any combination thereof.

Aspect 29: The method of any of aspects 23 through 28, wherein obtaining the uplink trigger comprises: obtaining an indication of a UE group associated with a UE, a UE identifier associated with the UE, a cell group associated with the UE, a cell identifier of the cell group associated with the UE, or any combination thereof, wherein the uplink trigger comprises the indication.

Aspect 30: The method of any of aspects 23 through 29, wherein the parameters associated with the ESRs, the CSRs, or both, comprise a first parameter associated with a duration of a monitoring window.

Aspect 31: The method of any of aspects 23 through 30, wherein outputting the indication of the parameters associated with the uplink trigger configuration comprises: outputting an indication of one or more waveforms associated with transmission of the uplink trigger by a UE, wherein the parameters comprise the indication of the one or more waveforms, and wherein obtaining the uplink trigger is based at least in part on the one or more waveforms.

Aspect 32: The method of aspect 31, wherein the one or more waveforms are associated with one or more uplink trigger sequences.

Aspect 33: The method of aspect 32, wherein a first set of uplink trigger sequences from the one or more uplink trigger sequences are associated with the ESRs and a second set of uplink trigger sequences from the one or more uplink trigger sequences are associated with the CSRs.

Aspect 34: The method of any of aspects 32 through 33, wherein outputting the indication of the parameters associated with the uplink trigger configuration comprises: outputting an indication of a scrambling sequence, wherein the scrambling sequence is based at least in part on an identifier associated with the network entity.

Aspect 35: The method of aspect 34, wherein the scrambling sequence is based at least in part on a SFN, a slot index, a counter, or any combination thereof.

Aspect 36: The method of any of aspects 32 through 35, wherein each of the one or more uplink trigger sequences are preceded by a training sequence, followed by a training sequence, or both.

Aspect 37: The method of any of aspects 32 through 36, wherein each of the one or more uplink trigger sequences are associated with a preamble.

Aspect 38: The method of aspect 31, wherein the one or more waveforms are associated with one or more chirps, and a first set of chirps from the one or more chirps are associated with the ESRs and a second set of chirps from the one or more chirps are associated with the CSRs.

Aspect 39: The method of any of aspects 23 through 31, wherein outputting the indication of the parameters associated with the uplink trigger configuration comprises: outputting an indication of a format associated the uplink trigger, wherein the format comprises a header, an address, an indication of the ESRs, the CSRs, or both, a CRC, a training sequence, or any combination thereof; and obtaining the uplink trigger in accordance with the indicated format.

Aspect 40: The method of any of aspects 23 through 39, further comprising: outputting control signaling indicating a duty cycle configuration associated with transmission of the uplink trigger, wherein obtaining the uplink trigger is based at least in part on the duty cycle configuration.

Aspect 41: The method of aspect 40, wherein the duty cycle configuration is based at least in part on a congestion level, a priority associated with the ESRs, a priority associated with the CSRs, an energy state of a UE, a power consumption associated with the transmission of the uplink trigger.

Aspect 42: The method of any of aspects 23 through 41, further comprising: receiving a report comprising an indication of one or more energy consumptions associated with transmission of the uplink trigger at different transmit power levels, a recommended duty cycle configuration, or both, wherein the indicated duty cycle configuration is based at least in part on the report.

Aspect 43: An apparatus for wireless communications at a UE, comprising a processor; memory coupled with the processor; and instructions stored in the memory and executable by the processor to cause the apparatus to perform a method of any of aspects 1 through 22.

Aspect 44: An apparatus for wireless communications at a UE, comprising at least one means for performing a method of any of aspects 1 through 22.

Aspect 45: A non-transitory computer-readable medium storing code for wireless communications at a UE, the code comprising instructions executable by a processor to perform a method of any of aspects 1 through 22.

Aspect 46: An apparatus for wireless communications at a network entity, comprising a processor; memory coupled with the processor; and instructions stored in the memory and executable by the processor to cause the apparatus to perform a method of any of aspects 23 through 42.

Aspect 47: An apparatus for wireless communications at a network entity, comprising at least one means for performing a method of any of aspects 23 through 42.

Aspect 48: A non-transitory computer-readable medium storing code for wireless communications at a network entity, the code comprising instructions executable by a processor to perform a method of any of aspects 23 through 42.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc. Disks may reproduce data magnetically, and discs may reproduce data optically using lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

The term “determine” or “determining” encompasses a variety of actions and, therefore, “determining” can include calculating, computing, processing, deriving, investigating, looking up (such as via looking up in a table, a database or another data structure), ascertaining and the like. Also, “determining” can include receiving (e.g., receiving information), accessing (e.g., accessing data stored in memory) and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. An apparatus for wireless communications at a user equipment (UE), comprising:
a processor;
memory coupled with the processor; and
instructions stored in the memory and executable by the processor to cause the apparatus to:
receive, from a network entity, an indication of parameters associated with an uplink trigger configuration, wherein the parameters are associated with energy scheduling requests, communication scheduling requests, or both;
transmit, via an active radio, an uplink trigger based at least in part on the uplink trigger configuration, wherein the uplink trigger comprises the energy scheduling requests, the communication scheduling requests, or both; and
monitor, via a backscatter radio, for energy grants, communication grants, or both, based at least in part on the uplink trigger, wherein the monitoring is based at least in part on the uplink trigger configuration.

2. The apparatus of claim 1, wherein the instructions are further executable by the processor to cause the apparatus to:
receive, via the backscatter radio, the energy grants, the communication grants, or both, based at least in part on the monitoring.

3. The apparatus of claim 1, wherein the instructions are further executable by the processor to cause the apparatus to:
transmit, via the active radio, a retransmission of the uplink trigger, based at least in part on failing to receive, via the backscatter radio, the energy grants, the communication grants, or both.

4. The apparatus of claim 1, wherein the instructions are further executable by the processor to cause the apparatus to:
transmit, via the backscatter radio, an acknowledgment message indicating reception of the parameters associated with the uplink trigger configuration.

5. The apparatus of claim 1, wherein the instructions are further executable by the processor to cause the apparatus to:
transmit a quantity of repetitions of the uplink trigger, wherein the quantity of repetitions is based at least in part on a coverage level of the UE, one or more signal measurements, a priority associated with the uplink trigger, the monitoring, or any combination thereof.

6. The apparatus of claim 5, wherein the instructions to transmit a quantity of repetitions of the uplink trigger are executable by the processor to cause the apparatus to:
transmit a first quantity of repetitions, a second quantity of repetitions, or a third quantity of repetitions based at least in part on a set of thresholds associated with a first coverage level, a second coverage level, a third coverage level, or any combination thereof.

7. The apparatus of claim 6, wherein the instructions are further executable by the processor to cause the apparatus to:
receive, from the network entity, an indication of the first quantity of repetitions, the second quantity of repetitions, the third quantity of repetitions, the set of thresholds, or any combination thereof.

8. The apparatus of claim 6, wherein the instructions are further executable by the processor to cause the apparatus to:
measure a reference signal receive power of one or more reference signal transmissions received via the backscatter radio; and
determine the coverage level of the UE based at least in part on the reference signal receive power of the one or more reference signal transmissions.

9. The apparatus of claim 1, wherein the instructions to transmit the uplink trigger are executable by the processor to cause the apparatus to:
transmit, via the active radio, an indication of a UE group associated with the UE, a UE identifier associated with the UE, a cell group associated with the UE, a cell identifier of the cell group associated with the UE, or any combination thereof, wherein the uplink trigger comprises the indication.

10. The apparatus of claim 1, wherein the parameters associated with the energy scheduling requests, the communication scheduling requests, or both, comprise a first parameter associated with a duration of a monitoring window, and wherein monitoring for the energy grants, the communication grants, or both, is based at least in part on the monitoring window.

11. The apparatus of claim 1, wherein the instructions to receive the indication of the parameters associated with the uplink trigger configuration are executable by the processor to cause the apparatus to:
receive an indication of one or more waveforms associated with transmission of the uplink trigger, wherein the parameters comprise the indication of the one or more waveforms, and wherein transmitting the uplink trigger is based at least in part on the one or more waveforms.

12. The apparatus of claim 11, wherein the one or more waveforms are associated with one or more uplink trigger sequences.

13. The apparatus of claim 12, wherein a first set of uplink trigger sequences from the one or more uplink trigger sequences are associated with the energy scheduling requests and a second set of uplink trigger sequences from the one or more uplink trigger sequences are associated with the communication scheduling requests, and the instructions are further executable by the processor to cause the apparatus to:
generate the first set of uplink trigger sequences and the second set of uplink trigger sequences based at least in part on a UE identifier, a cell identifier associated with the UE, or both.

14. The apparatus of claim 12, wherein the instructions to receive the indication of the parameters associated with the uplink trigger configuration are executable by the processor to cause the apparatus to:
receive an indication of a scrambling sequence, wherein the scrambling sequence is based at least in part on an identifier associated with the network entity; and
generate the one or more uplink trigger sequences based at least in part on the scrambling sequence.

15. The apparatus of claim 14, wherein the scrambling sequence is based at least in part on a system frame number, a slot index, a counter, or any combination thereof.

16. The apparatus of claim 12, wherein each of the one or more uplink trigger sequences are preceded by a training sequence, followed by a training sequence, or both.

17. The apparatus of claim 12, wherein each of the one or more uplink trigger sequences are associated with a preamble.

18. The apparatus of claim 11, wherein the one or more waveforms are associated with one or more chirps, and wherein a first set of chirps from the one or more chirps are associated with the energy scheduling requests and a second set of chirps from the one or more chirps are associated with the communication scheduling requests.

19. The apparatus of claim 1, wherein the instructions to receive the indication of the parameters associated with the uplink trigger configuration are executable by the processor to cause the apparatus to:
receive an indication of a format associated with the uplink trigger, wherein the format comprises a header, an address, an indication of the energy scheduling requests, the communication scheduling requests, or both, a cyclic redundancy check, a training sequence, or any combination thereof; and
transmit, via the active radio, the uplink trigger in accordance with the indicated format.

20. The apparatus of claim 1, wherein the instructions are further executable by the processor to cause the apparatus to:
receive, from the network entity, control signaling indicating a duty cycle configuration associated with transmission of the uplink trigger, wherein transmitting the uplink trigger is based at least in part on the duty cycle configuration.

21. The apparatus of claim 20, wherein the duty cycle configuration is based at least in part on a congestion level, a priority associated with the energy scheduling requests, a priority associated with the communication scheduling requests, an energy state of the UE, a power consumption associated with the transmission of the uplink trigger.

22. The apparatus of claim 20, wherein the instructions are further executable by the processor to cause the apparatus to:
transmit, to the network entity, a report comprising an indication of one or more energy consumptions associated with the transmission of the uplink trigger at different transmit power levels, a recommended duty cycle configuration, or both, wherein the indicated duty cycle configuration is based at least in part on the report.

23. An apparatus for wireless communications at a network entity, comprising:
a processor;
memory coupled with the processor; and
instructions stored in the memory and executable by the processor to cause the apparatus to:
output an indication of parameters associated with an uplink trigger configuration, wherein the parameters are associated with energy scheduling requests, communication scheduling requests, or both;
obtain an uplink trigger based at least in part on the uplink trigger configuration, wherein the uplink trigger comprises the energy scheduling requests, the communication scheduling requests, or both; and
output energy grants, communication grants, or both, based at least in part on the uplink trigger, wherein the outputting is based at least in part on the uplink trigger configuration.

24. The apparatus of claim 23, wherein the instructions are further executable by the processor to cause the apparatus to:
detect one or more uplink trigger sequences associated with the uplink trigger from a set of uplink trigger sequences based at least in part on an identifier associated with a UE, wherein outputting the energy grants, the communication grants, or both, is based at least in part on detecting the one or more uplink trigger sequences.

25. The apparatus of claim 24, wherein the instructions to detect the one or more uplink trigger sequence are executable by the processor to cause the apparatus to:
detect a preamble associated with the uplink trigger; and
search the set of uplink trigger sequences based at least in part on detecting the preamble, wherein detecting the one or more uplink trigger sequences from the set of uplink trigger sequences is based at least in part on the searching.

26. The apparatus of claim 24, wherein the instructions are further executable by the processor to cause the apparatus to:
estimate a frequency offset associated with the uplink trigger and a channel associated with the uplink trigger, wherein detecting the one or more uplink trigger sequences is based at least in part on the frequency offset and channel.

27. The apparatus of claim 23, wherein the instructions are further executable by the processor to cause the apparatus to:
obtain an acknowledgment message indicating reception of the parameters associated with the uplink trigger configuration by a user equipment (UE).

28. The apparatus of claim 23, wherein the instructions to obtain the uplink trigger are executable by the processor to cause the apparatus to:
obtain an indication of a UE group associated with a UE, a UE identifier associated with the UE, a cell group associated with the UE, a cell identifier of the cell group associated with the UE, or any combination thereof, wherein the uplink trigger comprises the indication.

29. A method for wireless communications at a user equipment (UE), comprising:
receiving, from a network entity, an indication of parameters associated with an uplink trigger configuration, wherein the parameters are associated with energy scheduling requests, communication scheduling requests, or both;
transmitting, via an active radio, an uplink trigger based at least in part on the uplink trigger configuration, wherein the uplink trigger comprises the energy scheduling requests, the communication scheduling requests, or both; and
monitoring, via a backscatter radio, for energy grants, communication grants, or both, based at least in part on the uplink trigger, wherein the monitoring is based at least in part on the uplink trigger configuration.

30. A method for wireless communications at a network entity, comprising:
outputting an indication of parameters associated with an uplink trigger configuration, wherein the parameters are associated with energy scheduling requests, communication scheduling requests, or both;
obtaining an uplink trigger based at least in part on the uplink trigger configuration, wherein the uplink trigger comprises the energy scheduling requests, the communication scheduling requests, or both; and
outputting energy grants, communication grants, or both, based at least in part on the uplink trigger, wherein the outputting is based at least in part on the uplink trigger configuration.
